(19) United States
(12) Patent Application Publication
(10) Pub. No.: US 2012/0276516 A1
(43) Pub. Date: Nov. 1, 2012

(54) SYSTEMS AND METHODS FOR PROVIDING LEARNING MODULES FOR LEARNING SYSTEMS

(76) Inventors: Matthew Robert Teskey, New Hamburg (CA); John Allan Baker, Waterloo (CA); Kenneth James Chapman, Kitchener (CA); Owen Cornelius Mullings, Kitchener (CA); Brian John Cepuran, Oakville (CA); Terri-Lynn Anne Brown, Calgary (CA)

(21) Appl. No.: 13/098,297

(22) Filed: Apr. 29, 2011

(51) Int. Cl. G09B 7/00

(52) U.S. Cl. 434/362

(57) ABSTRACT

A computer-implemented method for developing an educational course. The method includes defining at least one learning objective for the course, providing at least one course content module having educational material related to the at least one learning objective for the course, providing at least one assessment module for assessing a learner's performance in the course, generating at least one learning module based on at least one of the learning objectives, the learning module including one or more course content modules and assessment modules associated with that learning objective, and storing the at least one learning module in a data storage device.

### FIELD

The embodiments described herein relate to electronic learning, and more particularly to systems and methods for providing educational course design and assessment for electronic learning systems that include learning modules.

### INTRODUCTION

Electronic learning (also called e-Learning or eLearning) generally refers to learning where users engage in education related activities using computers and other computer devices. For examples, users may enroll or participate in a course or program of study offered by an educational institution (e.g. a college, university or grade school) through a web interface that is accessible over the Internet. Similarly, users may receive assignments electronically, participate in group work and projects by collaborating online, and be graded based on assignments and examinations that are submitted using an electronic dropbox or other similar service.

Electronic learning is not limited to use by educational institutions, however, and may also be used in governments or in corporate environments. For example, employees at a regional branch office of a particular company may use electronic learning to participate in a training course offered by another office without ever physically leaving their office.

In most electronic learning systems, some users are consumers or “learners” and will participate in courses (e.g. by listening or watching lectures, conducting assignments, and taking quizzes, etc.) while other users are providers or “instructors” who may be responsible for preparing the course framework, including the course structure and/or materials (e.g. determining what topics are to be covered in a particular course, what assignments will be required, how performance is to be assessed, etc.).

However, planning the framework of courses (e.g. selecting the course structure, organizing lecture materials, etc.) can be a difficult exercise. This is true generally with all forms of learning, but is particularly problematic in electronic learning systems.

For example, in a traditional course setting, it may be sufficient to prepare materials as the course is taught (e.g. a “just-in-time” approach) since the course normally follows a particular chronological sequence or timeline. However, in electronic learning systems some users may be progressing through the course content at different rates of speed, or may review educational modules in different orders depending on particular interests. Accordingly, it may be beneficial if the course structures and materials are determined in advance.

Many users lack the skills and training to properly prepare courses. In particular, users may not be familiar with the design or creation of electronic learning courses, and may be intimidated by concepts related to designing content and thus have difficulty in providing a course in an electronic learning system. In some cases, users may not be familiar with instructional theory to design courses that are pedagogically sound. Moreover, users who wish to design courses are often required to create everything for the course and they are often unable to take advantage of content and assessments that were previously generated for other courses.

### SUMMARY OF SOME EMBODIMENTS

According to one aspect there is provided a computer-implemented method for developing an educational course comprising: defining at least one learning objective for the course, providing at least one course content module having educational material related to the at least one learning objective for the course, providing at least one assessment module for assessing a learner's performance in the course, generating at least one learning module based on at least one of the learning objectives, the learning module including one or more course content modules and assessment modules associated with that learning objective, and storing the at least one learning module in a data storage device.

According to another aspect there is provided a computer-implemented educational method comprising providing an educational course having at least one learning module, the at least one learning module being generated based on a learning objective and including at least one assessment module associated with that learning objective, and identifying a competency level of at least one learner on the learning objective based on the at least one assessment module of the at least one learning module.

According to another aspect there is provided a computer-implemented method for developing an educational course comprising receiving at least one query associated with at least one desired learning objective, searching for one or more learning modules that are related to the at least one query, each learning module having been generated based on a learning objective and including one or more content modules and assessment modules associated with that learning objective, if one or more related learning modules are found, presenting the related one or more learning modules, and developing the educational course based on at least one of the presented one or more learning modules.

According to yet another aspect there is provided an educational system comprising at least one data storage device, and at least one processor coupled to the at least one data storage device, the at least one processor being adapted to define at least one learning objective for the course, provide at least one course content module having educational material related to the at least one learning objective for the course, provide at least one assessment module for assessing a learner's performance in the course, generate at least one learning module based on at least one of the learning objectives, the learning module including one or more course content modules and assessment modules associated with that learning objective, and store the at least one learning module in a data storage device.

According to yet another aspect there is provided an educational system comprising at least one data storage device, and at least one processor coupled to the at least one data storage device, the at least one processor being adapted to provide an educational course having at least one learning module, the at least one learning module being generated based on a learning objective and including at least one assessment module associated with that learning objective, and identify a competency level of at least one learner on the learning objective based on the at least one assessment module of the at least one learning module.

According to yet another aspect there is provided an educational system comprising at least one data storage device, and at least one processor coupled to the at least one data storage device, the at least one processor being adapted to receive at least one query associated with at least one desired learning objective, search for one or more learning modules that are related to the at least one query, each learning module having been generated based on a learning objective and including one or more content modules and assessment modules associated with that learning objective, if one or more related learning modules are found, present the related one or more learning modules, and develop the educational course based on at least one of the presented one or more learning modules.

### BRIEF DESCRIPTION OF THE DRAWINGS

For a better understanding of the embodiments described herein and to show more clearly how they may be carried into effect, reference will now be made, by way of example only, to the accompanying drawings which show at least one exemplary embodiment, and in which:

FIG. 1 is a block diagram illustrating an educational system for providing electronic learning according to one embodiment;

FIG. 2 is a flowchart showing a method for providing guided instructional design according to one embodiment;

FIG. 3 is a screenshot of a welcome page for a course design module in a system for providing guided instructional design according to some embodiments;

FIG. 4 is a screenshot of a choose competencies page for the course design module of FIG. 3;

FIG. 5 is a screenshot of an add competencies page for the course design module of FIG. 3;

FIG. 6 is a screenshot of a choose objectives page for the course design module of FIG. 3;

FIG. 7 is a screenshot of a classify objectives page for the course design module of FIG. 3;

FIG. 8 is a screenshot of an add objectives page for the course design module of FIG. 3;

FIG. 9 is a screenshot of a learning activities page for the course design module of FIG. 3;

FIG. 10 is a screenshot of a select common activities objectives page for the course design module of FIG. 3;

FIG. 11 is a screenshot of a create groups page for the course design module of FIG. 3;

FIG. 12 is a screenshot of a define educational modules page for the course design module of FIG. 3;

FIG. 13 is a screenshot of a course sequence page for the course design module of FIG. 3;

FIG. 14 is a screenshot of a select grading system page for the course design module of FIG. 3;

FIG. 15 is a screenshot of a create assessment schedule page for the course design module of FIG. 3;

FIG. 16 is a screenshot of a categorize grades page for the course design module of FIG. 3;

FIG. 17 is a screenshot of an assign weights page for the course design module of FIG. 3;

FIG. 18 is a screenshot of a completion page for the course design module of FIG. 3;

FIG. 19 is a screenshot of a course info page for a course design module in a system for providing guided instructional design according to another embodiment;

FIG. 20 is a screenshot of an instructor info page for the course design module of FIG. 19;

FIG. 21 is a screenshot of a course duration page for the course design module of FIG. 19;

FIG. 22 is a screenshot of a course sharing page for the course design module of FIG. 19;

FIG. 23 is a screenshot of an instructional goals page for the course design module of FIG. 19;

FIG. 24 is a screenshot of a course competencies page for the course design module of FIG. 19;

FIG. 25 is a screenshot of a learner characteristics page for the course design module of FIG. 19;

FIG. 26 is a screenshot of an instructional setting page for the course design module of FIG. 19;

FIG. 27 is a screenshot of a learning objectives page for the course design module of FIG. 19;

FIG. 28 is a screenshot of a course assessment page for the course design module of FIG. 19;

FIG. 29 is a screenshot of a course structure page for the course design module of FIG. 19;

FIG. 30 is a screenshot of a course sequence page for the course design module of FIG. 19;

FIG. 31 is a screenshot of a course components page for the course design module of FIG. 19;

FIG. 32 is a screenshot of a locate materials page for the course design module of FIG. 19;

FIG. 33 is a screenshot of a define additional materials page for the course design module of FIG. 19;

FIG. 34 is a screenshot of a course review page for the course design module of FIG. 19;

FIG. 35 is a screenshot of a completion page for the course design module of FIG. 19;

FIG. 36 is a screenshot of a course builder module for displaying course framework information according to one embodiment;

FIG. 37 is a detail view of a course framework from the course builder of FIG. 36 according to one embodiment;

FIG. 38 is a detail view of a course framework from the course builder of FIG. 36 according to another embodiment;

FIG. 39 is a detail view of a course framework from the course builder of FIG. 36 according to yet another embodiment;

FIG. 40 is a block diagram showing a plurality of content modules and assessment modules of an exemplary educational course that may be provided by the system shown in FIG. 1;

FIG. 41 is a block diagram showing learning modules that are generated based on association between some components of the educational course shown in FIG. 40;

FIG. 42 is an exemplary search interface that may be provided by the system shown in FIG. 1 with results of a query for learning modules and which may be used for developing an educational course according to some embodiments;

FIG. 43 shows the search interface in FIG. 42 with results of a another query;

FIG. 44 is a flowchart showing one example of how a learner might engage with the course shown in FIG. 40;

FIG. 45 is an image of a page of a course design module according to one embodiment adapted to associate learning objectives with one or more course items;

FIG. 46 is an image of a page of a course design module adapted to present one or more learning objectives to be associated with one or more course items;

FIG. 47 is an image of a page for associating learning objectives without evaluation modules;

FIG. 48 is an image of a page for associating learning objectives with evaluation modules;

FIG. 49 is an image of a page for associating learning objectives with evaluation modules and goals;

FIG. 50 is an image of a page of a course design module adapted to allow learning objectives to be associated with particular content modules;

FIG. 51 is an image of a page of a course design module adapted to allow subcomponents of an assessment to be associated with a particular learning objective;

FIG. 52 is an image of a page of a course design module adapted to prompt a user to provide a learning objective assessment method for quizzes;

FIG. 53 is a block diagram illustrating the steps of a computer-implemented educational method for creating a course according to another embodiment;

FIG. 54 is a block diagram illustrating the steps of a computer-implemented educational method for identifying competency of a learner for a learning objective according to yet another embodiment; and

FIG. 55 is a block diagram illustrating the steps of a computer-implemented educational method for creating a course according to yet another embodiment.

### DETAILED DESCRIPTION

For simplicity and clarity of illustration, where considered appropriate, reference numerals may be repeated among the figures to indicate corresponding or analogous elements or steps. In addition, numerous specific details are set forth in order to provide a thorough understanding of the exemplary embodiments described herein. However, it will be understood by those of ordinary skill in the art that the embodiments described herein may be practiced without these specific details. In other instances, well-known methods, procedures and components have not been described in detail so as not to obscure the embodiments generally described herein.

Furthermore, this description is not to be considered as limiting the scope of the embodiments described herein in any way, but rather as merely describing the implementation of various embodiments as described.

The embodiments of the systems and methods described herein may be implemented in hardware or software, or a combination of both. For example, some embodiments may be implemented in computer systems and computer programs, which may be stored on a physical computer readable medium, executable on programmable computers (e.g. computing devices and/or processing devices) each comprising at least one processor, a data storage system (including volatile and non-volatile memory and/or storage elements), at least one input device (e.g. a keyboard or mouse), and at least one output device (e.g. a display screen, a network, or a remote server). For example and without limitation, the programmable computers may include servers, personal computers, laptops, netbook computers, personal data assistants (PDA), cell phones, smart phones, gaming devices, and other mobile devices.

In some embodiments, program code can be applied to input data to perform the functions described herein and to generate output information. The output information can then be supplied to one or more output devices for outputting to one or more users.

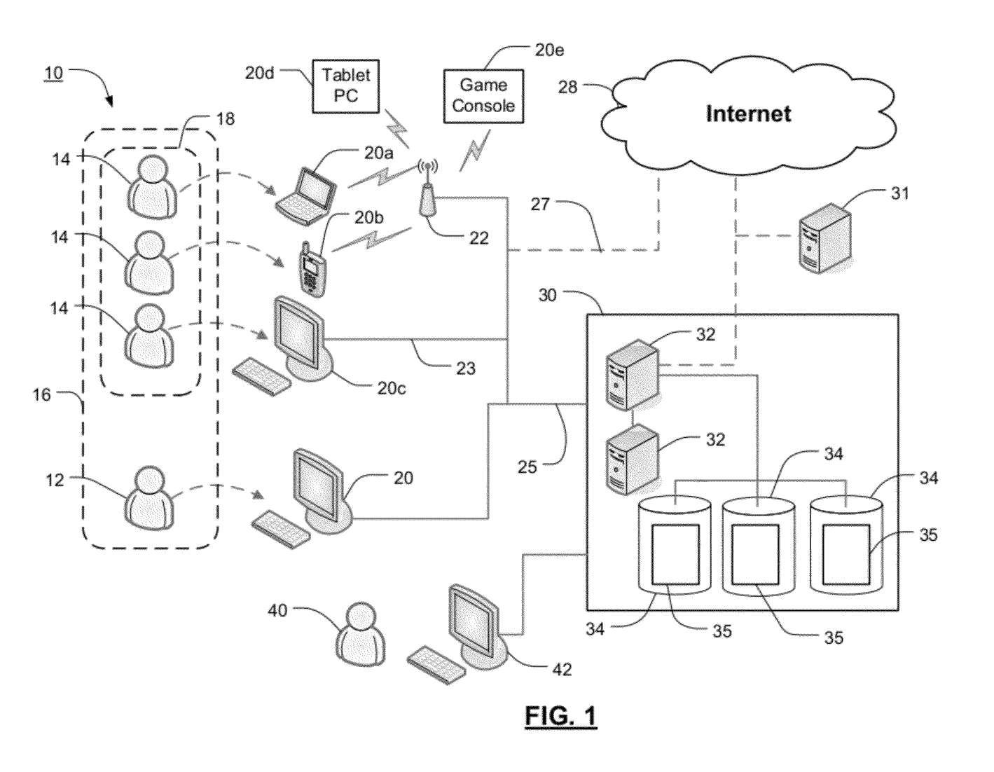

Turning now to FIG. 1, illustrated therein is an educational system 10 for providing electronic learning according to some embodiments for providing guided instructional design according to some embodiments.

Using the system 10, one or more users 12, 14 may communicate with an educational service provider 30 to participate in, create, and consume electronic learning services, including courses. In some embodiments, the educational service provider 30 may be part of or associated with a traditional “bricks and mortar” educational institution (e.g. a grade school, university or college), another entity that provides educational services (e.g. an online university, a company that specializes in offering training courses, or an organization that has a training department), or may be an independent service provider (e.g. for providing individual electronic learning). It should be understood that a course is not limited to formal courses offered by formal educational institutions. The course may include any form of learning instruction offered by an entity of any type. For example, the course may be a training seminar at a company for a small group of employees or a professional certification program with a larger number of intended participants (e.g. PMP, CMA, etc.).

In some embodiments, one or more educational groups can be defined that includes one or more of the users 12, 14. For example, as shown in FIG. 1, the users 12, 14 may be grouped together in an educational group 16 representative of a particular course (e.g. History 101, French 254), with a first user 12 or “instructor” being responsible for providing the course (e.g. organizing lectures, preparing assignments, creating educational content etc), while the other users 14 or “learners” are consumers of the course content (e.g. users 14 are enrolled in the course).

In some examples, the users 12, 14 may be associated with more than one educational group (e.g. the users 14 may be enrolled in more than one course, the first user may be enrolled in at least one course and is responsible for teaching at least one other course, or the first user 12 may be responsible for teaching more than one courses).

In some embodiments, educational sub-groups may also be formed. For example, two of the users 14 are shown as part of educational sub-group 18. The sub-group 18 may be formed in relation to a particular project or assignment (e.g. sub-group 18 may be a lab group) or based on other criteria. In some embodiments, due to the nature of the electronic learning, the users 14 in a particular sub-group 18 need not physically meet, but may collaborate together using various tools provided by the educational service provider 30.

In some embodiments, other groups 16 and sub-groups 18 could include users 14 that share common interests (e.g. interests in a particular sport), that participate in common activities (e.g. users that are members of a choir or a club), and/or have similar attributes (e.g. users that are male, users under twenty-one years of age, etc.).

Communication between the users 12, 14 and the educational service provider 30 can occur either directly or indirectly using any suitable computing device. For example, the user 12 may use a computing device 20 such as a desktop computer that has at least one input device (e.g. a keyboard and a mouse) and at least one output device (e.g. a display screen and speakers).

The computing device 20 can generally be any suitable device for facilitating communication between the users 12, 14 and the educational service provider 30. For example, the computing device 20 could be a laptop 20a wirelessly coupled to an access point 22 (e.g. a wireless router, a cellular communications tower, etc.), a wirelessly enabled personal data assistant (PDA) 20b or smart phone, a terminal 20c, a tablet computer 20d, or a game console 20e over a wired connection 23.

The computing devices 20 may be connected to the service provider 30 via any suitable communications channel. For example, the computing devices 20 may communicate to the educational service provider 30 over a local area network (LAN) or intranet, or using an external network (e.g. by using a browser on the computing device 20 to browse to one or more web pages presented over the Internet 28 over a data connection 27).

In some examples, one or more of the users 12, 14 may be required to authenticate their identities in order to communicate with the educational service provider 30. For example, the users 12, 14 may be required to input a login name and/or a password or otherwise identify themselves to gain access to the system 10.

In some examples, one or more users (e.g. “guest” users) may be able to access the system without authentication. Such guest users may be provided with limited access, such as the ability to review one or more components of the course, for example, to decide whether they would like to participate in the course.

In some embodiments, the wireless access points 22 may connect to the educational service provider 30 through a data connection 25 established over the LAN or intranet. Alternatively, the wireless access points 22 may be in communication with the educational service provider 30 via the Internet 28 or another external data communications network. For example, one user 14 may use a laptop 20a to browse to a webpage that displays elements of an electronic learning system (e.g. a course page).

The educational service provider 30 generally includes a number of functional components for facilitating the provision of social electronic learning services. For example, the educational service provider 30 generally includes one or more processing devices 32 (e.g. servers), each having one or more processors. The processing devices 32 are configured to send information (e.g. HTML or other data) to be displayed on one or more computing devices 20 in association with the social electronic learning system 10 (e.g. course information). In some embodiments, a processing device 32 may be a computing device 20 (e.g. a laptop or personal computer).

The educational service provider 30 also generally includes one or more data storage devices 34 (e.g. memory, etc.) that are in communication with the processing devices 32, and could include a relational database (such as a SQL database), or other suitable data storage devices. The data storage devices 34 are configured to host data 35 about the courses offered by the service provider (e.g. the course frameworks, educational materials to be consumed by the users 14, records of assessments done by users 14, etc.) as will be described below.

The data storage devices 34 may also store authorization criteria that define what actions may be taken by the users 12, 14. In some embodiments, the authorization criteria may include at least one security profile associated with at least one role. For example, one role could be defined for users who are primarily responsible for developing an educational course, teaching it, and assessing work product from other users for that course. Users with such a role may have a security profile that allows them to configure various components of the course, post assignments, add assessments, evaluate performance, and so on.

In some embodiments, some of the authorization criteria may be defined by specific users 40 who may or may not be part of the educational community 16. For example, users 40 may be permitted to administer and /or define global configuration profiles for the system 10, define roles within the system 10, set security profiles associated with the roles, and assign the roles to particular users 12, 14 in the system 10. In some embodiments, the users 40 may use another computing device (e.g. a desktop computer 42) to accomplish these tasks.

The data storage devices 34 may also be configured to store other information, such as personal information about the users 12, 14 of the system 10, information about which courses the users 14 are enrolled in, roles to which the users 12, 14 are assigned, particular interests of the users 12, 14 and so on.

The processing devices 32 and data storage devices 34 may also provide other electronic learning management tools (e.g. allowing users to add and drop courses, communicate with other users using chat software, etc.), and/or may be in communication with one or more other vendors that provide the tools.

In some embodiments, the system 10 may also have one or more backup servers 31 that may duplicate some or all of the data 35 stored on the data storage devices 34. The backup servers 31 may be desirable for disaster recovery (e.g. to prevent undesired data loss in the event of an event such as a fire, flooding, or theft).

In some embodiments, the backup servers 31 may be directly connected to the educational service provider 30 but located within the system 10 at a different physical location. For example, the backup servers 31 could be located at a remote storage location at a distance from the service provider 30, and the service provider 30 could connect to the backup server 31 using a secure communications protocol to ensure that the confidentiality of the data 35 is maintained.

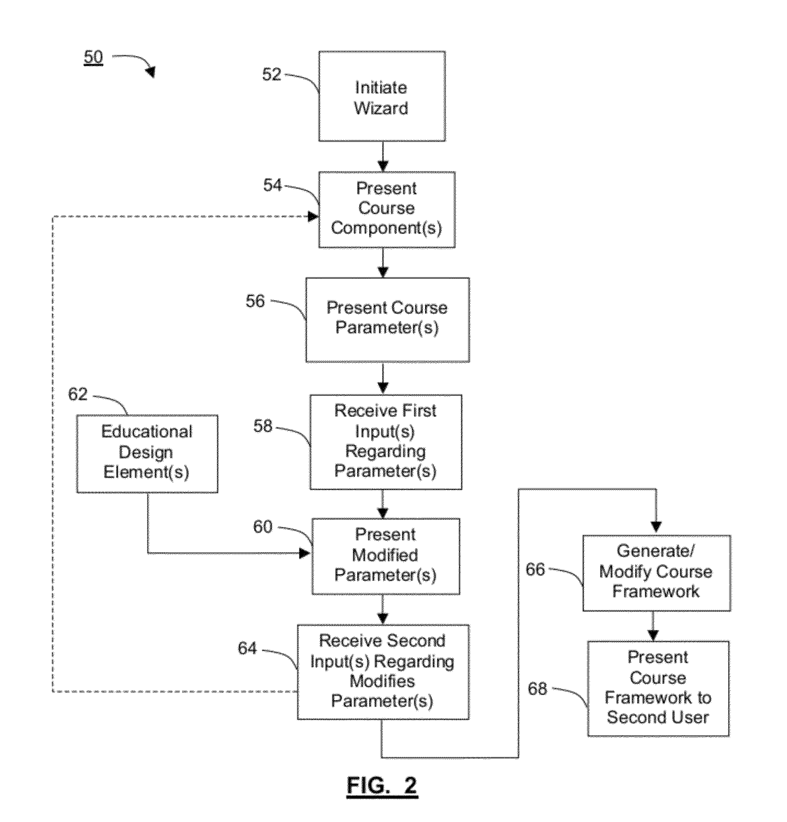

Turning now to FIG. 2, illustrated therein is a method 50 of providing guided instructional design according to one embodiment. For example, in some embodiments, the method 50 may be provided using the system of FIG. 1.

At step 52, a first user (e.g. a user 12) desiring to generate a course will activate a course design module (e.g. a course wizard or module, such as the modules 100 and 200 described below). Generally the course design module will be operating on one or more processing devices, which could be a server (e.g. server 32) as well as computing devices 20.

At step 54, the course design module presents the user with one or more course components. Course components are generally broad “functions” that describe the various aspects of the course within the framework that can be configured, such as course information, competencies, course goals, assessments, materials, etc. In some embodiments, the course components can be considered as including broad components (e.g. course info) and narrower sub-components (e.g. basic course information, instructor info, course duration, etc.) that fall under the heading of a broader course component. The user, for example, may be an instructor or any other user that contributes to developing the course.

At step 56, for each course parameter is presented for each course component. Course parameters are individual educational elements within the course components, and can include natural language objects and controls, as will be described in greater detail below.

At step 58, the course design module receives at least one first input in relation to at least one of the course parameters from a first user (e.g. user 12). For example, the user may input a title for the course, input educational materials (e.g. slides, readings, audio recordings), select course competencies and objectives, etc. which the user desires to include as part of the customized course framework.

At step 60, in response to the first inputs received from the user, as well as from educational design elements (see box 62) (e.g. predefined educational theory components, decision trees for the system 10) the course design module then generates and presents at least one modified course parameters. For example a modified course parameter could be a suggestion about a particular course structure the user may wish to take, a presentation of a predefined list of course objectives or competencies based on previously received input (e.g. the first inputs).

At step 64, the course design module receives at least one second input associated with the modified course parameter from the first user. For example, the user may select a particular course objective from a list presented at step 62. In some embodiments, for example, where there are additional course components to review, the method 50 can return from step 64 back to step 54, where a different course component can be presented. In other embodiments, the method 50 can proceed from step 64 to step 66.

At step 66, the system (e.g. system 10) generates a customized course framework based on the first and second inputs received from the first user. In some embodiments, where the customized course framework has already been generated, the system may alternatively modify the customized course framework.

At step 68, the course framework may be presented to a second user (e.g. users 12 who are participating in the course). This may be in response to a request from the second user to access his or her course information, for example.

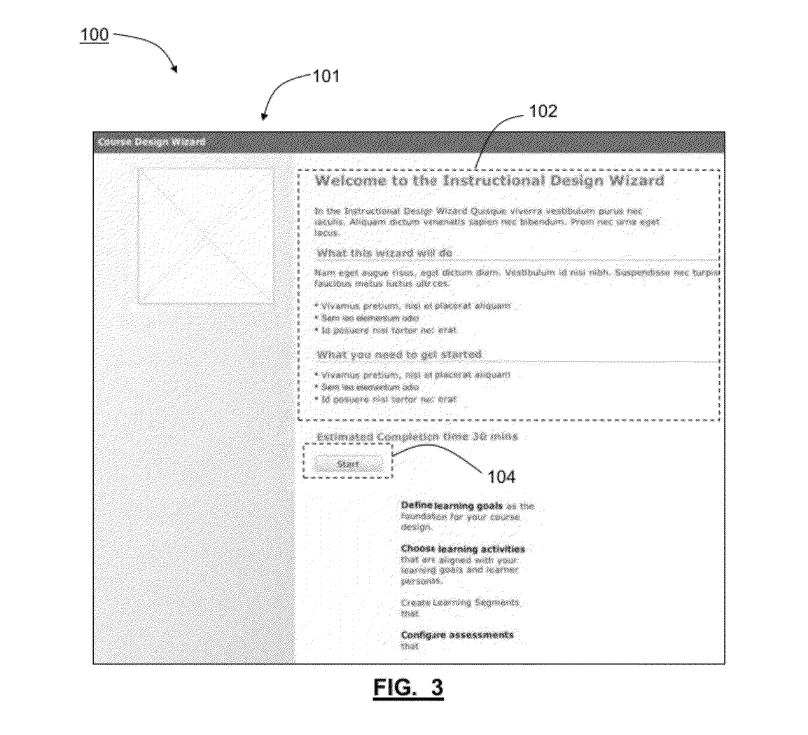

Turning now to FIG. 3, a screenshot of a welcome page 101 for a course design module 100 for a system for providing guided instructional design is shown according to one embodiment. For example, the course design module 100 may be provided using the system 10 generally as described above.

When the user (e.g. first user 12) initiates the course design module 100, one or more course components may be presented to the user in relation to the particular course being designed. Each course component also includes one or more course parameters, which are elements of the various course components and which may guide the user through the course design process (e.g. using natural language elements), and will respond dynamically to inputs from the user in order to generate and/or modify a customized course framework for that course.

In particular, the course parameters may provide guidance to the user in selecting and arranging various elements for the course. Normally, the course parameters include objects (e.g. text) presented to the user in a plain or natural language format using terminology that will be familiar to the user. For example, the natural language may include terms selected from known educational terms (e.g. terms taken from Bloom's educational taxonomy, etc.)

The course parameters may also include one or simpler graphical user interface (GUI) controls (e.g. text boxes, radio buttons, check boxes, dropdown lists, etc.) for receiving input from the user in association with some of the natural language objects.

By using a combination of natural language objects and simple controls, the user (who will often have limited programming or other computer skills) can select desired course elements (e.g. course competencies, objectives, modules, learning materials, etc.) that can then be used to generate a customized course framework.

Returning again to FIG. 3, the welcome page 101 (and other pages) of the course design module 100 may be presented as one or more webpages that may be accessed using a web browser (e.g. Internet Explorer, Firefox, Safari, Chrome, etc.) using one or more computing devices 20. For example, as shown, the welcome page 101 is presented as a webpage that includes a plurality of display areas (e.g. one or more frames).

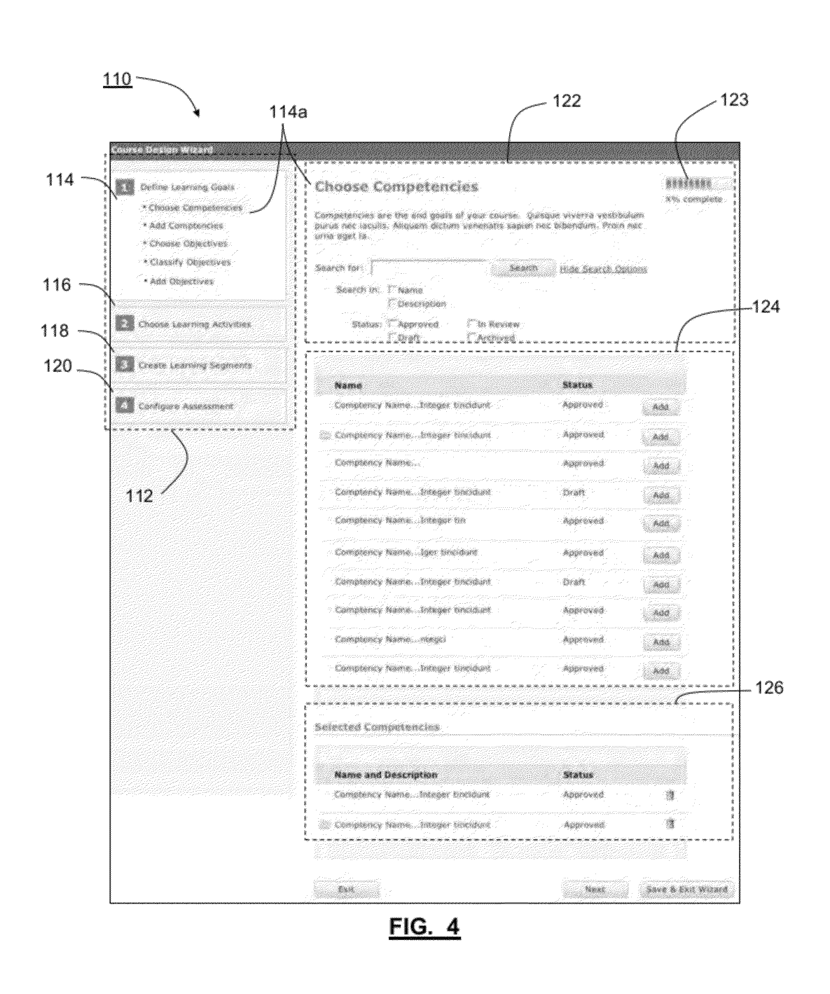

As shown, the welcome page 101 can include one or more text areas 102 (which may include some introductory remarks, information that may assist the user 12 in preparing a particular course, etc.). The welcome page 101 also include controls such as “start” button 104, which initiates the course design module 100 (and may activate the chose competencies page 110 shown in FIG. 4).

In some embodiments, the welcome page 101 may require the user to authenticate him or herself (e.g. using a login name and password) to navigate through the course design module 100.

The sequence of the course design module 100 can vary greatly, but in some embodiments the first page that is displayed after the welcome page is a choose competencies page 110 (as shown in FIG. 4).

In this embodiment, the choose competencies page 110 includes a progress indicator area 112 provided on a left side of the page 110, and one or more content areas 122, 124, 126 provided on a right side of the page 110. It will be understood, however, that the particular position and size of the areas on the webpage may be generally varied and is shown only here according to one exemplary configuration.

The progress indicator area 112 may show some or all of the course components for the particular course that the user is generating. The progress indicator area 112 may also be modified as the user moves through the course design module 100 (e.g. the list of items in the progress indicator 112 area may dynamically change as course competencies are added, for example).

Each course component is normally presented using natural language that the user would be familiar with and/or capable of understanding. For example, in this embodiment, the progress indicator area 112 lists four board course components: define learning goals 114, choose learning activities 116, create learning segments 118, and configure assessment 120. These four course components have natural language identifiers that use terms based in educational theory and would be familiar to some if not most users of the learning system 10.

The progress indicator area 112 may also show the relative location of the user as the user navigates through the course design module 100. For example, as shown in FIG. 4, the active course component (or sub-component) is highlighted. In this figure, the course sub-component is “choose competencies” 114a (which is a sub-component of the defined learning goals 114 component). The term “choose competencies” 114a is also displayed as the title of the page 110 within the content area 122.

As shown, each of the content areas 122, 124, 126 may include one or more course parameters that may include one or more natural language objects and one or more controls.

As discussed above, the course parameters are presented to guide the user through the course design process, and can assist the user by prompting the user for specific inputs (e.g. text inputs, decisions, etc.) associated with specific language objects. Based on those inputs the system can then generate a customized framework for that course. In some embodiments, the course parameters may be adapted to assist the user in designing a generally pedagogically sound course.

Previous inputs may also be used to modify or generate new course parameters that are presented to the user. For example, as shown in FIG. 4, the first content area 122 includes a first course parameter with a control (e.g. a search box) that allows the user to search for course competencies. For example, the user can input one or more keywords into the search box and then activate the search by activating a control, such as the “search” button shown. In some instances, the search box may allow for advanced search options (e.g. Boolean searching, etc.).

Generally, course competencies are broad goals for the course, and could include standardized competencies, such as prerequisites for taking the course (e.g. course participants are expected to have satisfied US high school level biology requirements), as well as desired post-course competencies (e.g. the course participants must meet specific standards for grade schools as defined by a state or other government entity, the participants must have an understanding of biology at a first year university level, etc.). The term “course competencies” is a natural language term based on educational theory that will be understood by the user.

In this embodiments, the results of the search conducted using the first content area 122 can then be displayed in a second content area 124 as another course parameter (e.g. a list of user-selectable course competencies).

In some embodiments, the list may be generated from a predefined data set, which may be stored in one or more of the data storage devices 34. The predefined data set may be predefined by another user (e.g. user 40), by an organization, or by the first user (e.g. user 14).

As shown, the list may also display some predefined properties for each competency, such as the name, status (e.g. approved by the educational institution, pending approval, draft for submission, etc.), and a description about the competency (and/or a link to more information).

The list may also include a control (e.g. an “add” button) for each particular competency. For example, by selecting the “add” button, the user can choose to add one or more competencies to the course. In some embodiments, some competencies may be automatically added, for example where they are mandatory (e.g., required by an organization that governs accreditation, required by an organization's administration, etc.) for a particular course.

On the choose competencies page 110 the third content area 126 shows another course parameter, which is a list of the currently selected course competencies. In some embodiments, the user may be able to delete competencies from this list using another control (e.g. by selecting a trash icon).

Generally, the choose competencies page 110 of the course design module 100 can assist the user in finding potential competencies from predefined data (e.g. the user can use keywords to find competencies), presents the results so they can be reviewed by the user, and then allows desired competencies to be added. The use of natural language (e.g. including educational theory terms), simple controls (e.g. search boxes, buttons, etc.), and dynamic parameters (e.g. search results) that respond to user inputs will be intuitive to most users and will tend to make it easy for the users to design particular components of the course.

In some embodiments, one more of the pages (e.g. the choose competencies page 110) may include a progress bar 123 that indicates a percentage of the course design process that has been completed.

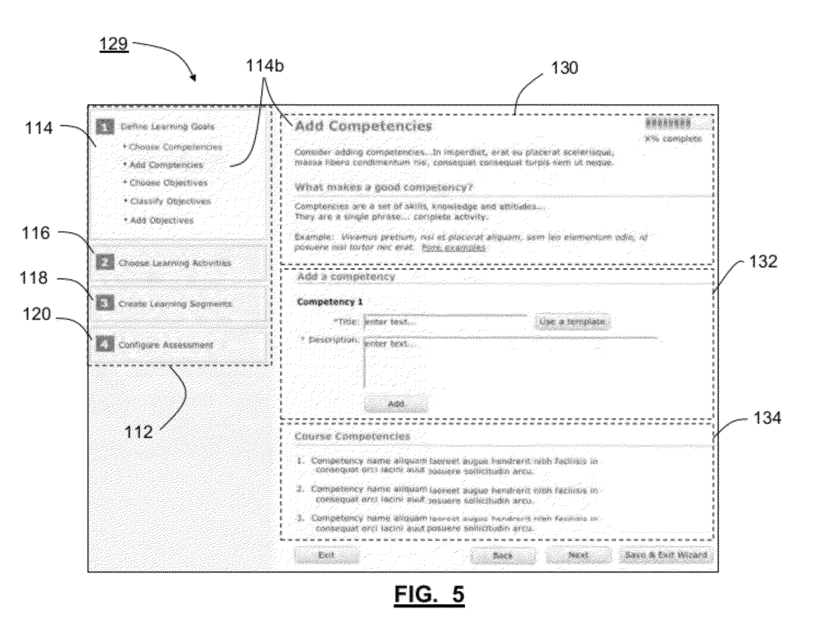

In some instances, the user may not find a desired competency on the choose competencies page 110. For example, the predefined competency list may not have a particular competency being searched for. Accordingly, the user may wish to create customized course competencies for this course. The user can then proceed to an add competencies page 129 as shown in FIG. 5. In this figure, the active course sub-component is “add competencies” 114b, as highlighted in the progress indicator area 112 and listed as the title of the page 129.

The add competencies page 129 includes a first content area 130 which can include natural language objects (e.g. text and other information) which may be useful in explaining to the user how a course competency may be created. The first content area 130 may also include links to more information or examples, which can be useful if the user desires more information, such as from an external webpage or another page within the course design module 100.

The add competencies page 129 also includes a second content area 132 with course parameters related to adding a new competency. For example, the second content area 132 prompts the user to enter text information (such as a title and a description for the new competency) using various controls, and then allows the user to add the competency to that course using another control (e.g. an “add” button). The user may also be presented with a control to select a template for creating the new competency (for example, an existing competency may be used as a template).

The current list of competencies for the course is shown in a third content area 134, which can dynamically respond to the inputs (e.g. text inputs and selections) of the user.

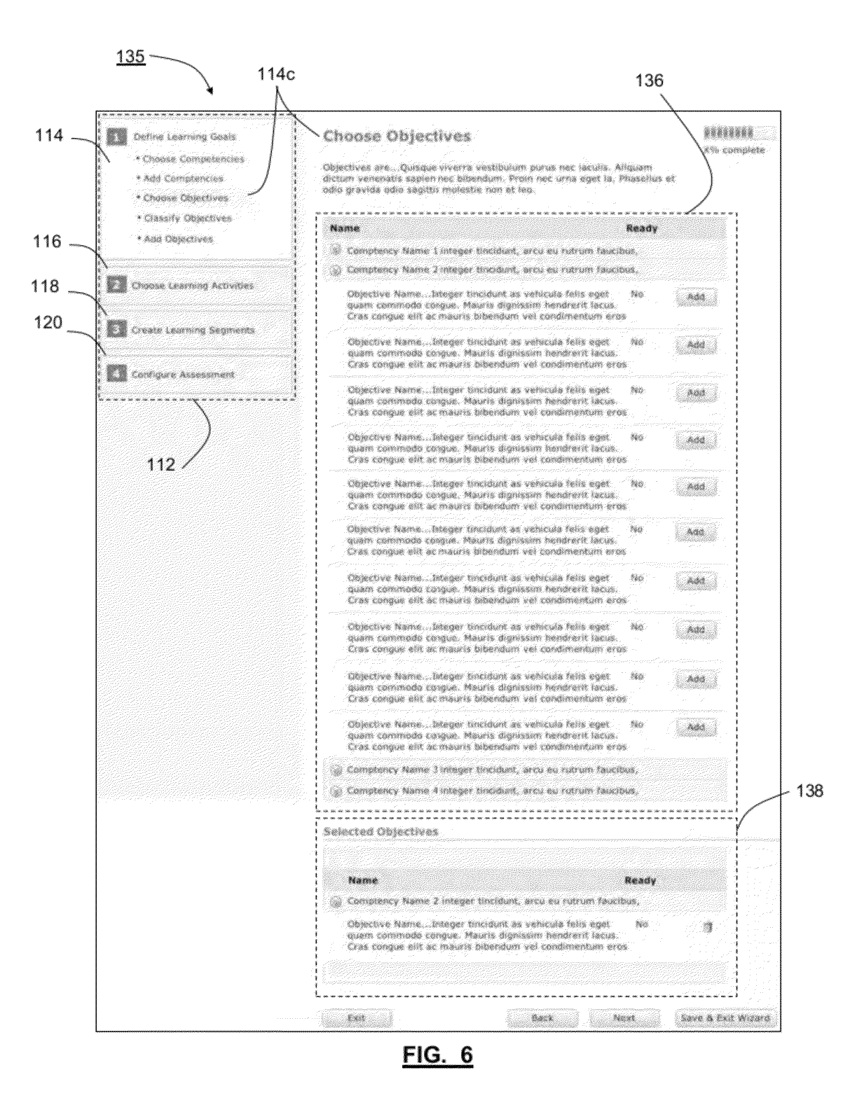

Turning now to FIG. 6, once the user has added the desired competencies to the course, the user can navigate to a choose course objective page 135. In this figure, the active course sub-component is “choose objectives” 114c, as highlighted in the progress indicator area 112 and listed as the page title.

Generally speaking, course objectives are more narrowly defined goals that are associated with particular course competencies. For example, course objectives may include performance skills, behavioral objectives, performance objectives and knowledge development objectives. For instance, in a biology course, a course competency could include “understand basic plant biology”, course objectives could include the participants performing laboratory experiments, classifying plants and animals, and describe the ecological role of fungi.

On the choose course objectives page 135, a first content area 136 displays course parameters that include a list of course objectives presenting in a natural language format, and button control for adding each objective to the course.

In some embodiments, the list of course objectives may be stored in one or more data storage devices 34, and may be generated based on one or more competencies that were previously selected by the user (e.g. using the choose competencies page 110). For example, for each particular course competency, the choose objectives page 135 may suggest certain course objectives based on a previous user inputs and educational design elements (e.g. aspects of educational theory, historical design information, etc.), and then allow the user to select the desired objectives from the suggested lists.

On this page 135, the selected course objectives for each particular course competency are displayed within a second content area 138.

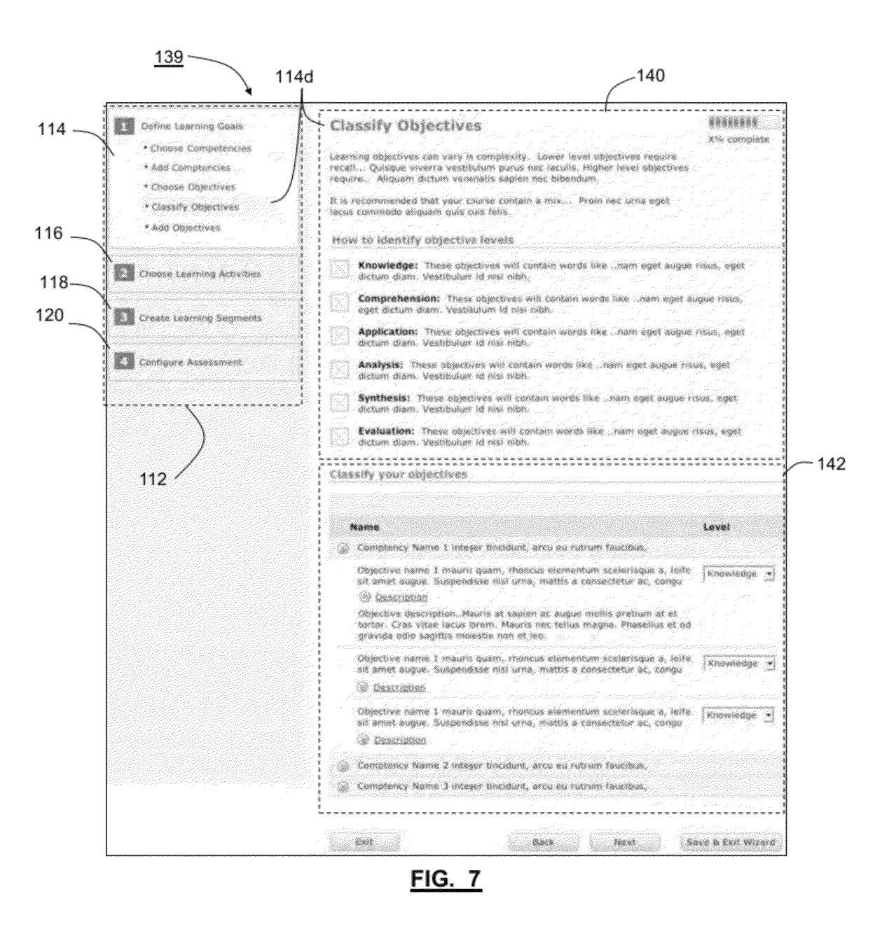

Turning now to FIG. 7, after the course objectives have been selected, the user may then navigate to a classify objectives page 139. In this figure, the active course sub-component is “classify objectives” 114d, as highlighted in the progress indicator area 112 and listed as the page title.

Various learning objectives can vary in complexity and type, and it may be desirable to provide a mixture of different types of objectives. For example, according to some educational theories course objectives can be grouped into different categories or levels, such as “knowledge”, “comprehension”, “application”, “analysis”, “synthesis”, and “evaluation”.

As shown in FIG. 7, a first content area 140 may provide information about the various categories of objectives in natural language familiar to the user. The second content area 142 on the other hand may include simple controls that allow the user to associate previously selected course competencies (e.g. the course competencies listed in the content area 138 in FIG. 6) with particular educational levels or categories (e.g. knowledge, comprehension, etc.), for example using a dropdown list.

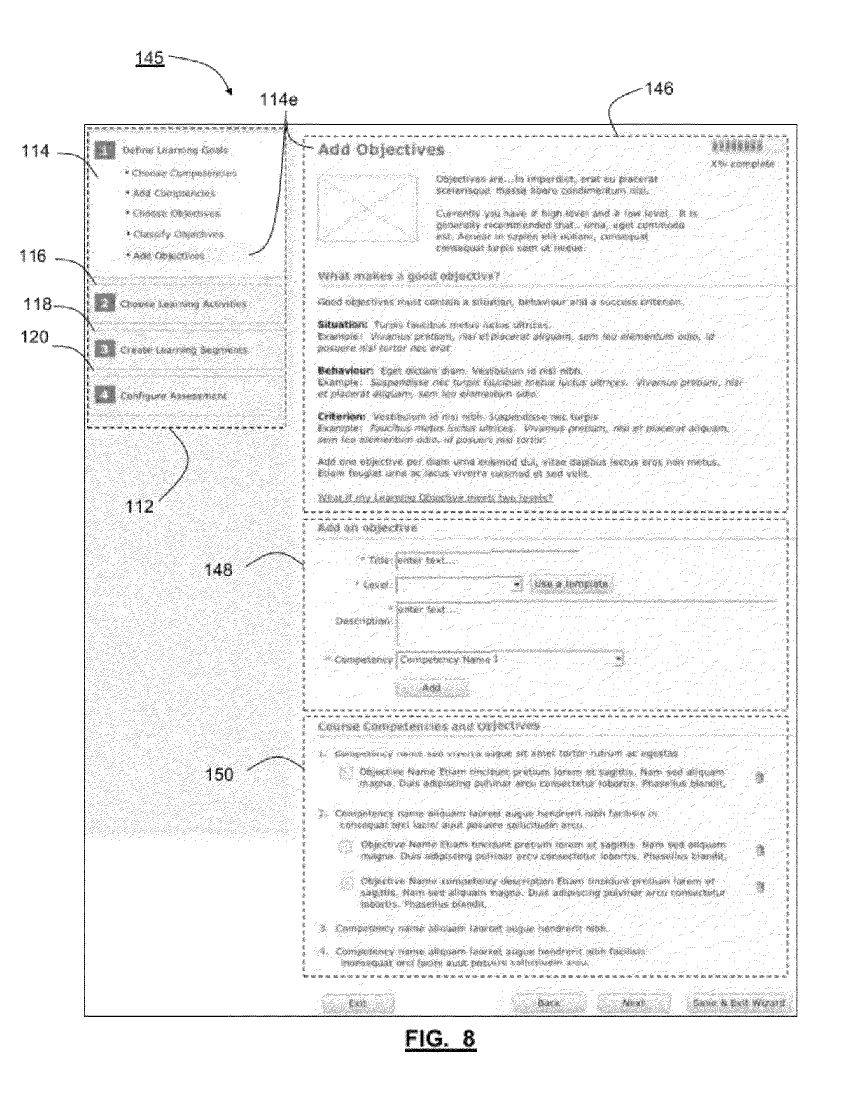

In some embodiments, the course objectives (e.g. as shown in content area 136) may not satisfy all the course objectives desired by the user. Accordingly, an add objectives page 145 for the course design module 100 may be presented to the user, as shown in FIG. 8. In this figure, the active course sub-component is “add objectives” 114e, as highlighted in the progress indicator area 112 and listed as the page title.

As shown, a first content area 146 may include text and other items that provide the user with guidance about adding a new course objective. For example, the content area 146 may include natural language terms that explain what makes a “good objective” as well as definitions of terms for the user to review, which could be based on educational theories.

The second content area 148 includes course parameters related to adding a course objective. For example, as shown the user is prompted to provide a title for the course objective in a text box control, select a suitable level or category (e.g. knowledge, comprehension, etc.) from a dropdown list control, enter a description in another text box control, and select a competency which the new objective will be attached to (e.g. one of the previously defined competencies) using another dropdown list. The new objective can then be added to the course using an “add” button.

On this page 145, a third content area 150 lists the current course competencies and selected course objectives for the competencies.

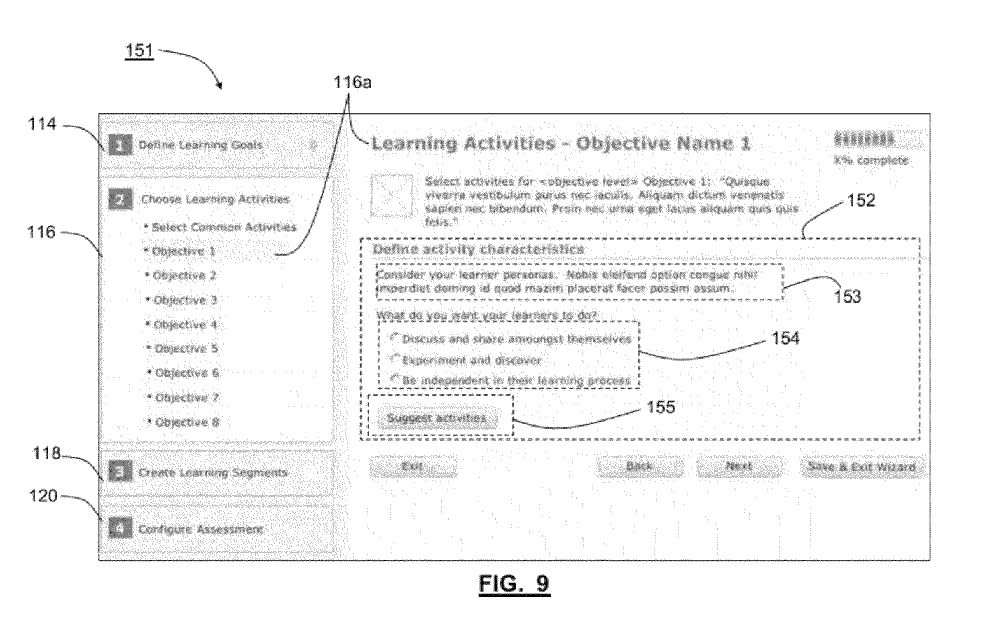

Turning now to FIG. 9, the user may be presented with a learning activities objectives page 151 for adding one or more activities to each of the course objectives. In this figure, another broad course component (e.g. choose learning activities 116) is presented to the user via one or more sub-components. For example, the active course sub-component is “Objective Name 1” 116a, as highlighted in the progress indicator area 112 and listed as the page title, which corresponds to the first objective selected using the choose objectives page 135.

This page includes a first content area 152 which can include course parameters, such as natural language text about things the user should consider when defining activities 153, radio button controls 154 for selecting particular activity types (e.g. whether the course participants should be independent, work as a group, or experiment and discover), and a button control 155 for suggesting activities given the inputs of the user in combination with education design elements (e.g. educational theories, educational taxonomies, etc.).

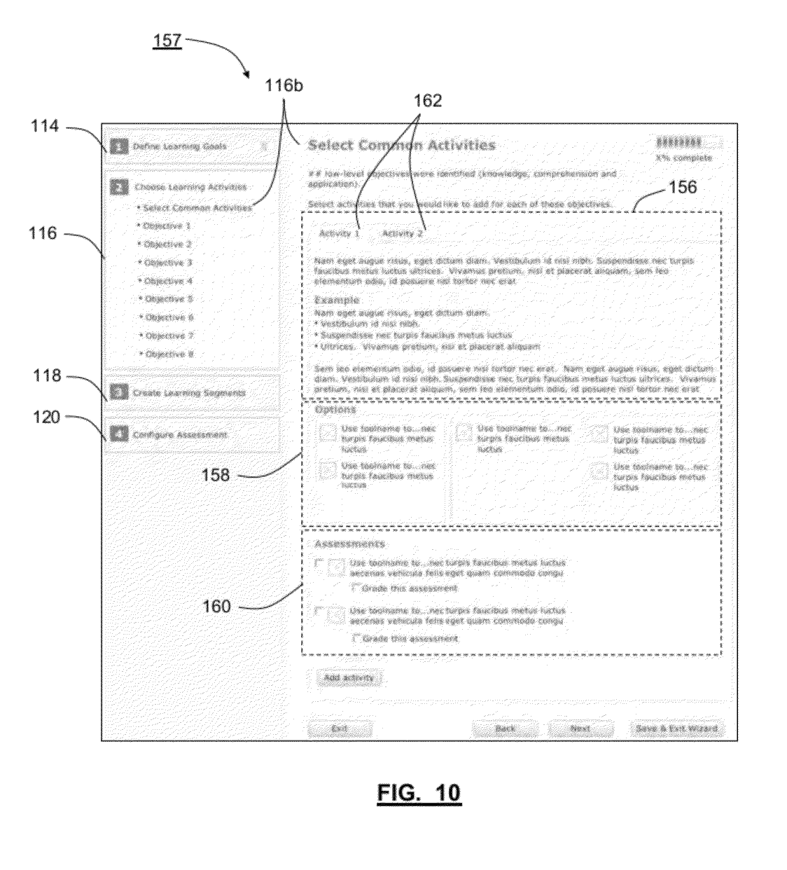

For example, suggested activities may be displayed on a select common activities page 157 as shown in FIG. 10. In this figure, the active sub-component is “Select Common Activities” 116b.

The select common activities page 157 allows one or more activities to be associated with the previously defined course objectives. For example, in a biology course, suppose that one of the course objectives includes the requirement that course participants be able to perform basic biology laboratory experiments. Using the page 157 shown in FIG. 10, the user could then select suitable activities for reaching that course objective, such as: reviewing lab equipment to learn equipment names, preparing an experiment plan with group, conducting the experiment, and preparing a report about the experiment.

The suggested activities can be displayed in a first content area 156, where the activities may be explained in plain language and possibly organized using tabs 162. The user may select particular options for each activity using controls provided in a second content area 158. In some embodiments, a third content area 160 may display one or more assessments that can be associated with the particular activities.

Generally, the learning activities page 151 and select common activities page 157 may be displayed for each of the previously selected course objectives so that the desired course framework can be developed.

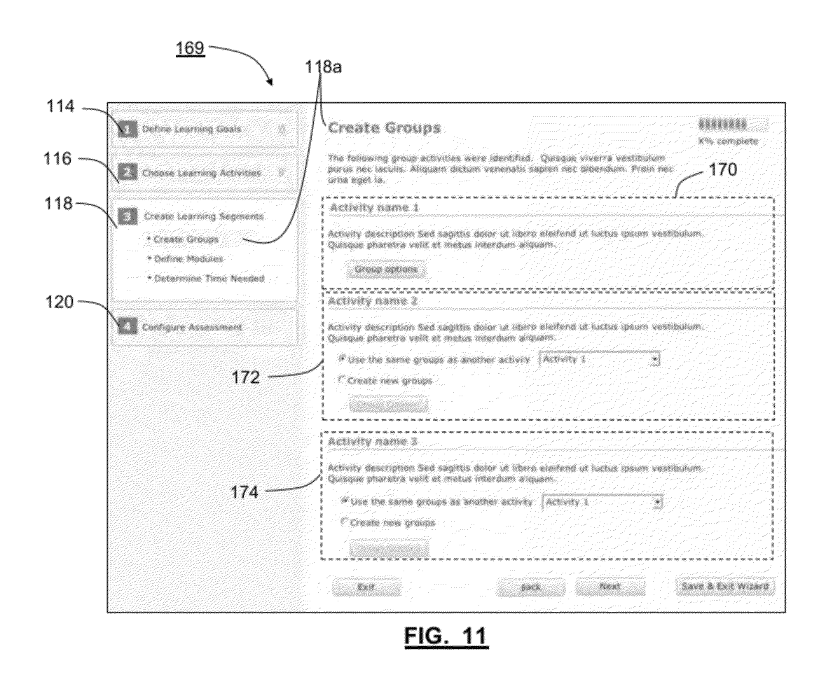

Turning now to FIG. 11, for some activities the user may desire to organize the participants into groups (e.g. users 14 may be organized into a group 18). If so, the create groups page 169 may be displayed. On this figure, the sub-component “create groups” 118a of the course component create learning segments 118 is active.

The create groups page 169 can be used to define group options (e.g. the number of users in each group, whether the users can create their own groups or have groups randomly assigned, whether the same groups are to be used for multiple activities, etc.) using course parameters providing in various content areas.

For example, as shown three content areas 170, 172, 174 are presented for three activities. The first content area 170 presents course parameters for a first activity including natural language objects, and allows group options to be selected using controls. The second and third content areas 172, 174 allow previously defined groups to be used or a new group to be created for each of the activities.

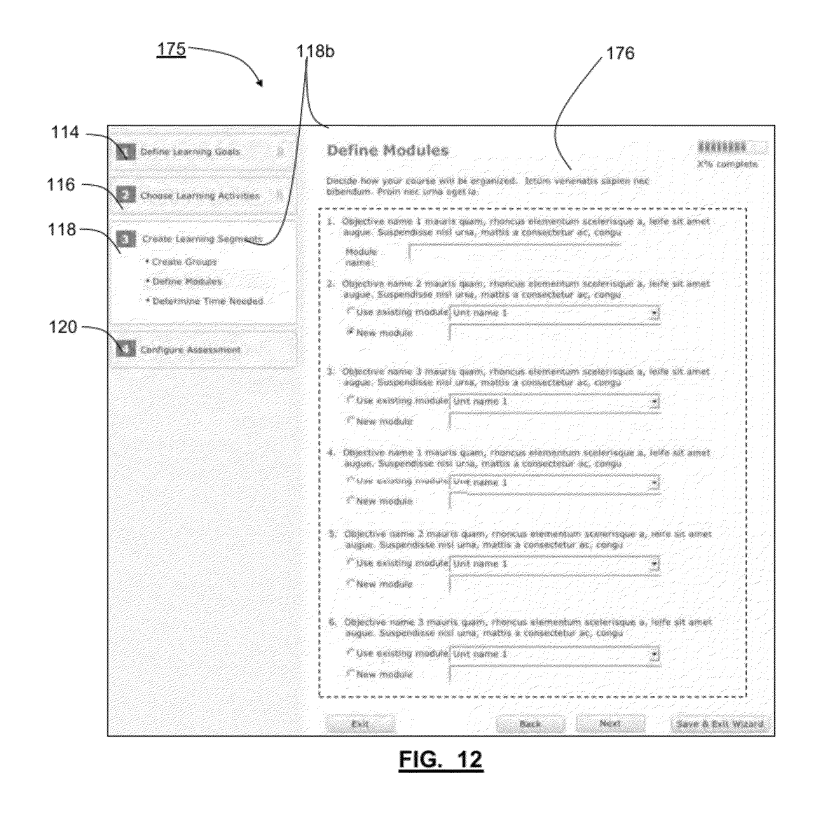

Turning now to FIG. 12, the next step in the course design module 100 may be to define educational modules using a define modules page 175. Generally, each educational module may be a functional group of one or more of the previously defined course objectives (e.g. an educational unit or topic) which defines how the course is to be organized. For example, in a math course, educational modules could be topics such as: fractions, addition, multiplication, exponents, etc.

As shown, various course parameters can be displayed in a content area 176, and include controls that allow the user to select modules for each of the previously defined course objectives (e.g. using radio buttons and dropdown lists).

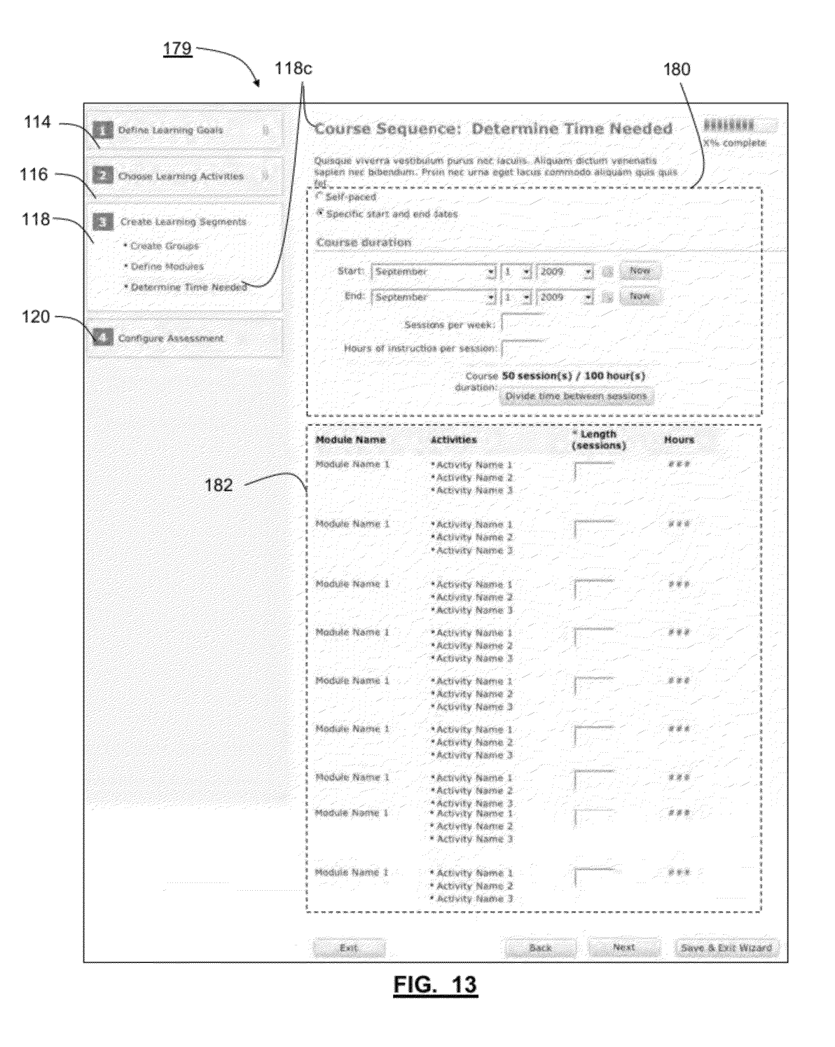

Turning now to FIG. 13, once the course modules have been defined, these can be displayed as parameters on a course sequence page 179. The course sequence page 179 can include a plurality of language objects and controls for creating a temporal structure to the course. This may include making the course self-paced or defining specific start and end dates, associating the course with calendar days or months, and determining the number of sessions per week (as shown in the first content area 180), as well as assigning time or sessions for each of the previously defined educational modules.

Turning now to FIG. 14, the next step in the course design module 100 may be to present the user with a select grading system page 183. In this figure, another broad course component (e.g. configure assessment 120) is presented to the user, with the course sub-component “select grading system” 120a being active.

On this page 183, the user can select one or more grading systems for the course based on the displayed course parameters displayed in content areas 184, 186 (which could include suggesting proposed course grading systems as natural language objects and presenting controls such as radio buttons and checkboxes for selecting the desired grading system).

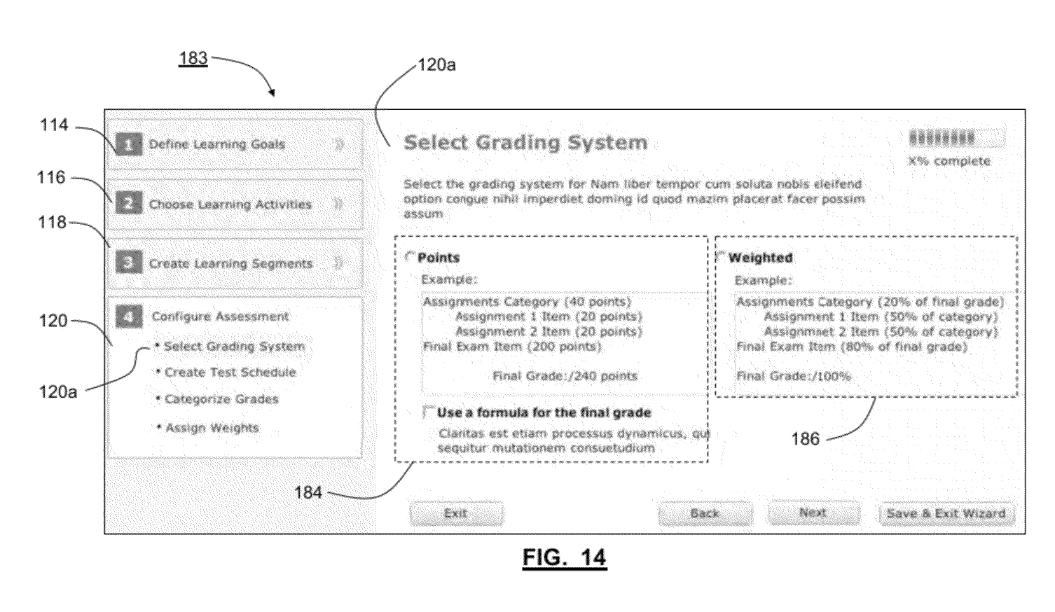

Once the grading system has been selected, the assessment schedule can be determined using as assessment schedule page 189 as shown in FIG. 15. In this figure, the active sub-component is “create test schedule”. This page 189 may present course parameters including natural language information about various types of tests (e.g. progress tests and comprehensive tests) displayed in a first content area 190, controls for adding a test in a second content area 191, and a course sequence displayed in a third content area 192 (and including one or more test events 193 therein).

In some embodiments, the natural language information or objects may be based on educational theory. For example, information as to whether a certain type of assessment (e.g. a multiple choice exam) is appropriate for particular subject matter (e.g. math courses) may be presented.

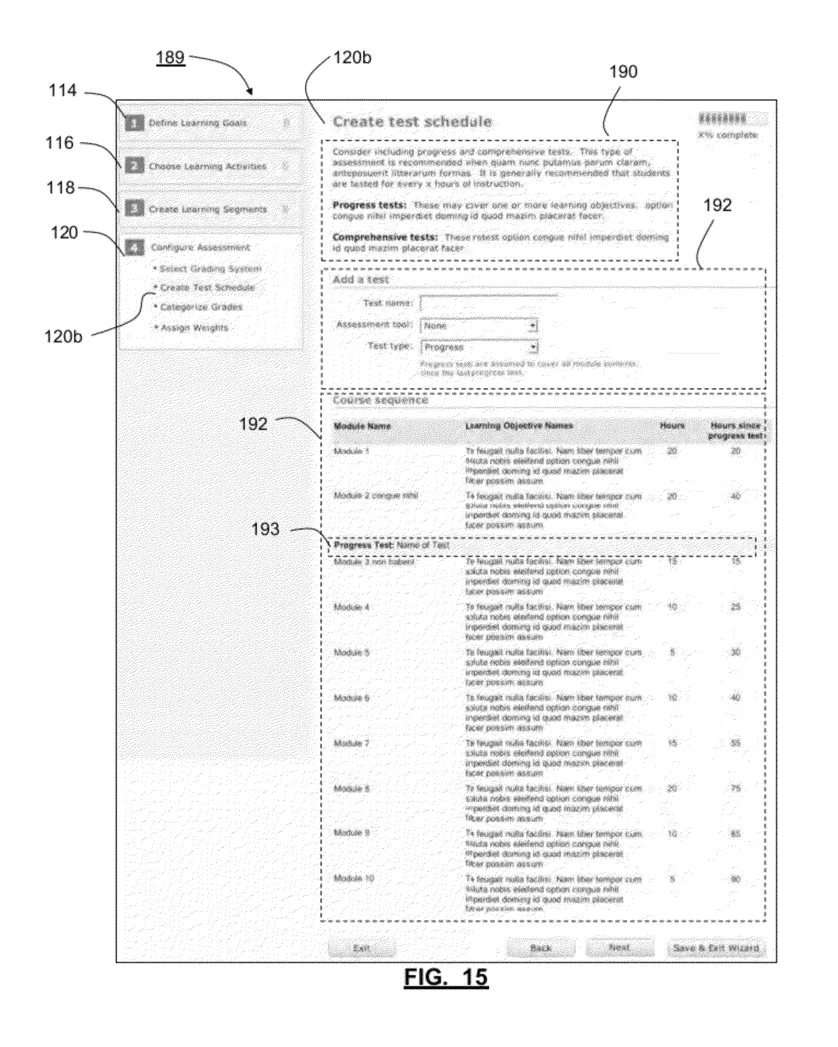

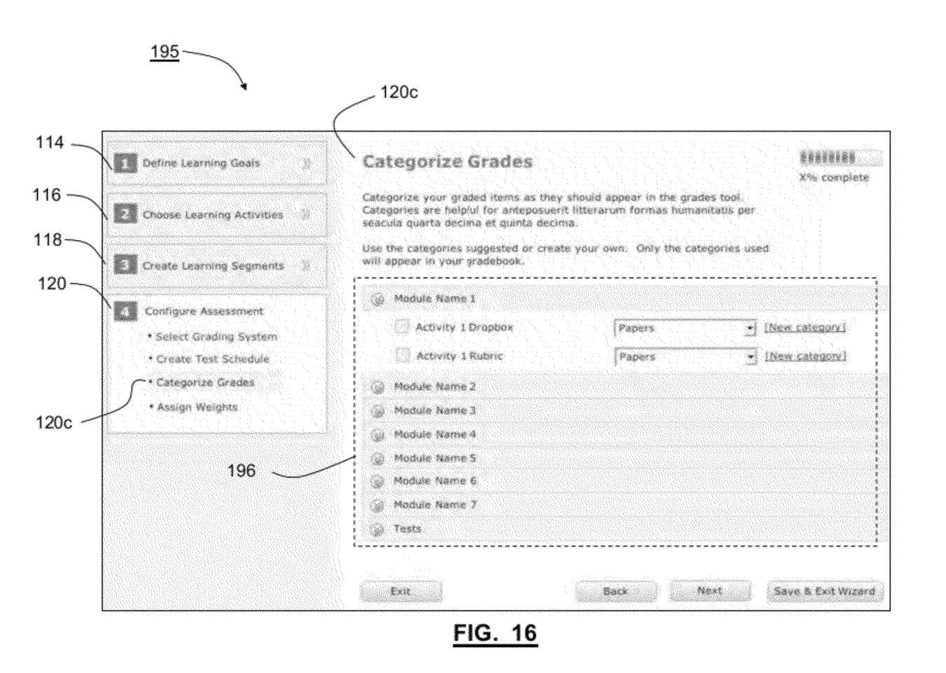

The next step in the course design module 100 may be to categorize grades using a categorize grades page as shown in FIG. 16. The active sub-component in this figure is “categorize grades” 120c.

Using the categorize grades page 195, the user can categorize the graded items (e.g. assignments, etc.) as they should appear in a grades tool, for example. Course parameters may be presented in a content area and include a list of the modules and activities, as well as tests, and may allow the user to intuitively categorize the graded items for those activities and tests (in some cases using predefined categories or by allowing the user to generate new categories).

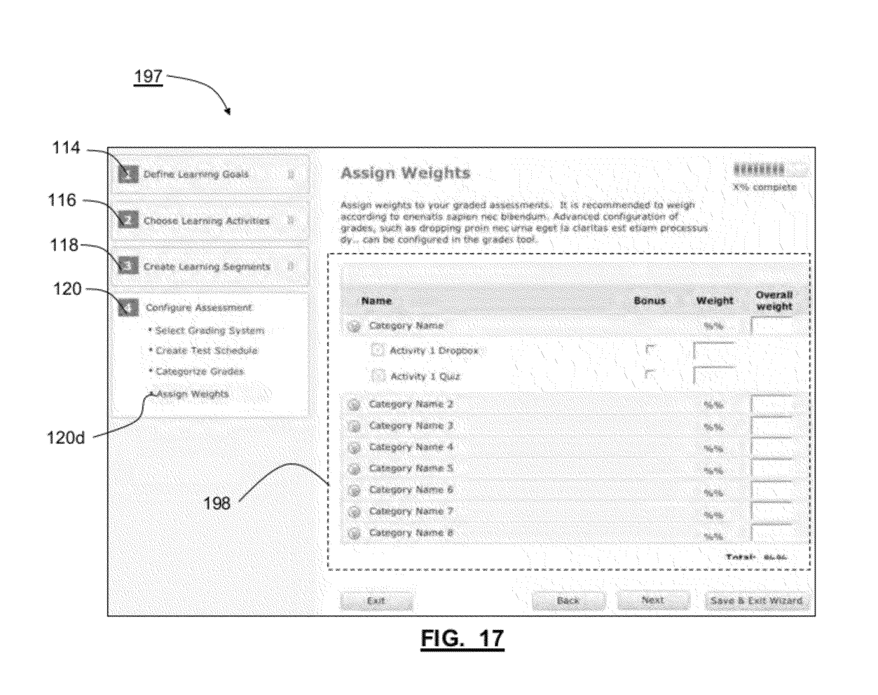

Finally, as shown on FIG. 17, in some embodiments the user may be presented with the option to assign weights for the different activities using an assign weights page 197. For example, the previously defined categories and activities may be presented along with various controls (e.g. text boxes, checkboxes, etc.) for selecting the desired weights.

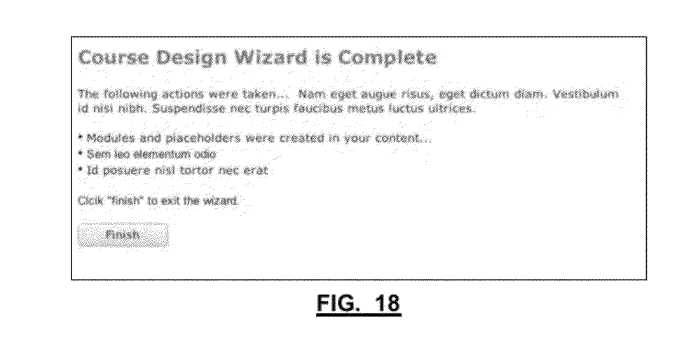

The course design module 100 is now complete, and the user can be presented with a completion page as shown in FIG. 18. The completion page may include a summary of the actions taken in designing the course, and may also allow the user to re-enter the course design module 100 to make changes, edit various course parameters, etc.

The course design module 100 can now generate a customized course framework for this course. The course framework can incorporate all of the various elements (e.g. competencies, objectives, activities, assessments, etc.) as based on the inputs from the user at the various stages of the course design module as well as educational design elements (e.g. educational theories, decision matrices for particular educational institutions, historical information, etc.).

At this point the user may be free to assign content and assessments to the framework provided with confidence that they are following educational “best-practices”. In some embodiments, the user may assign content and assessments via a “drag-n-drop” interface to take their specific materials and align them to the objectives and activities that they set out using the course design module 100.

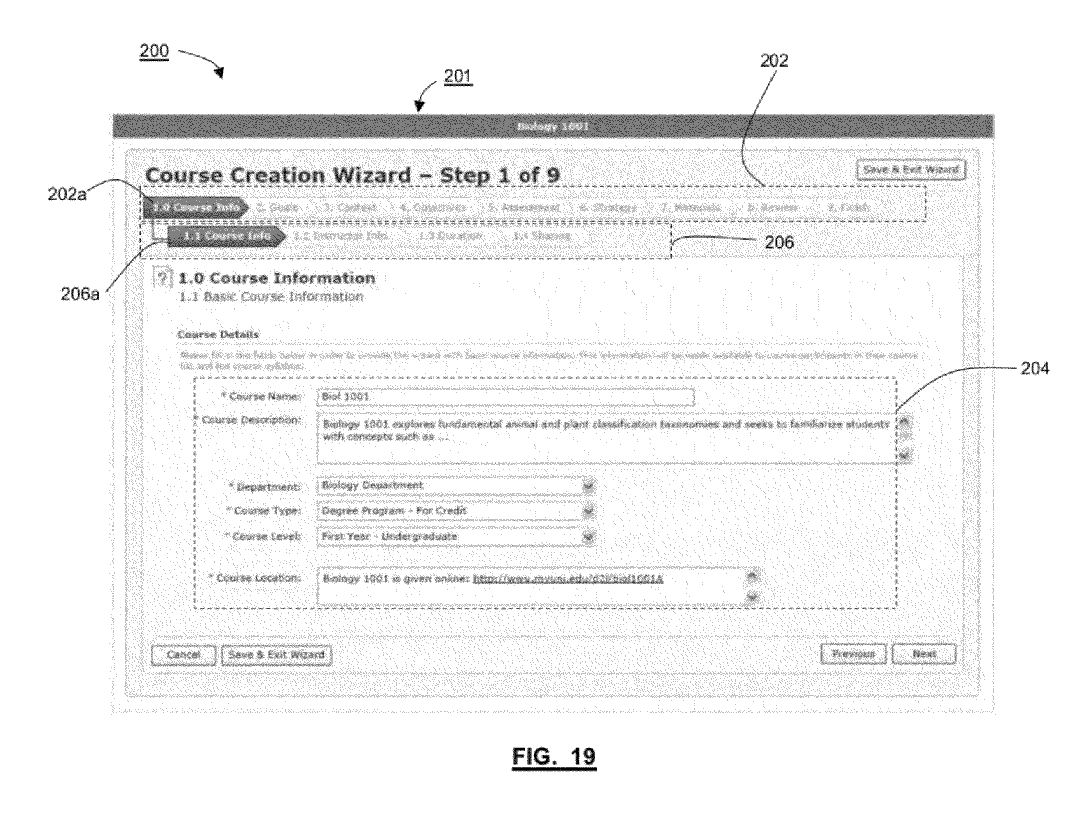

Turning now FIG. 19, illustrated therein is a course design module 200 (or “course design wizard”) according to yet another embodiment.

Generally, the course design module 200 is similar to the course design module 100, and presents course parameters for the user, receives inputs from the user in association with those course parameters, and then repeatedly presents new or modified course parameters based on those inputs until the course design is completed. Once complete, the course design module 200 can generate a customized course framework that incorporates the various elements selected and organized by the user.

For example, the course design module 200 includes a course info page 201, which may be the first page displayed to the user. The various pages (including the course info page 201) may display various course components 202 (e.g. goals, context, objectives, assessments, strategies, materials, etc.), with the currently active component highlighted (e.g. “course info” 202a).

Various sub-components for each component may also be listed, where applicable. For example, in this embodiment the sub-components 206 are listed and a “course info” sub-component 206a is active.

The course info page 201 can display course parameters in a content area 204. As with the course design module 100 above, the course parameters can generally include information presented to the user as natural language objects (e.g. text, which may or may not be rooted in educational theories and taxonomies), as well as controls for receiving inputs from the user in association with the natural language objects.

For example, as shown in FIG. 19 the user could be prompted to input text information about the course name, description and location using text field controls, select department, course type and level from dropdown lists.

Various controls can also be used to navigate through the various pages of the course design module 200 (e.g. buttons for “Next”, “Previous”, “Save & Exit Wizard”, etc.).

Turning now to FIG. 20, an instructor info page 207 of the course design module 200 may be the next screen presented to the user (with the “instructor info” 206b sub-component being active). This page 207 may prompt the user to input information about the instructor, such as name, email address, office information, and office hours using text fields.

The user may also be able to associate other users (e.g. teaching assistants, lab technicians, etc.) with the course. These added users may be displayed as a list that is dynamically updated in response to the user inputs.

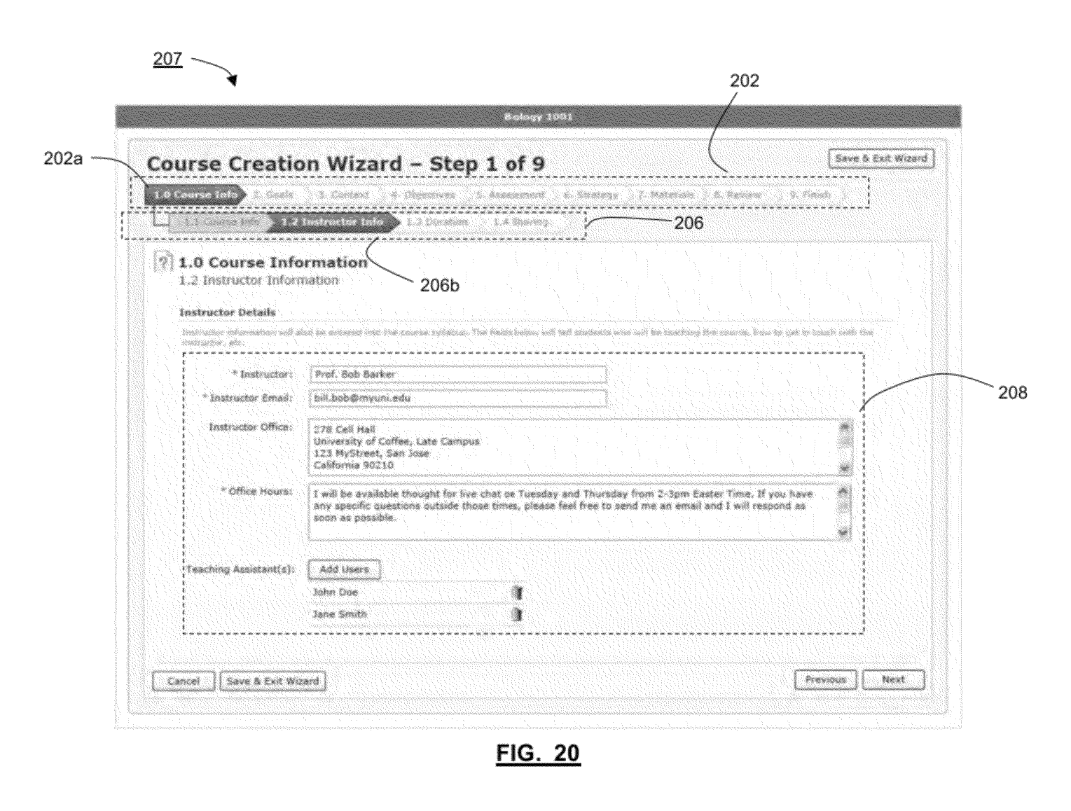

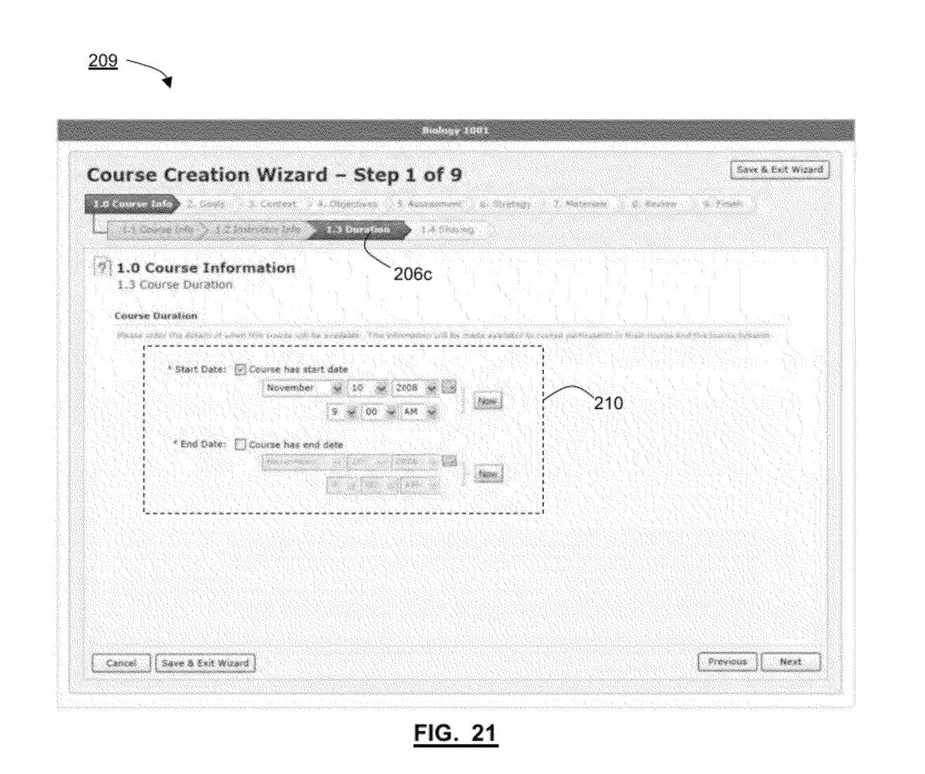

Turning now to FIG. 21, the next page in the course design module 200 may be a course duration page 209, which may allow the user to select start and end dates for the course using various controls shown in the content area 210. The “duration” 206c sub-component is highlighted as being active in this Figure.

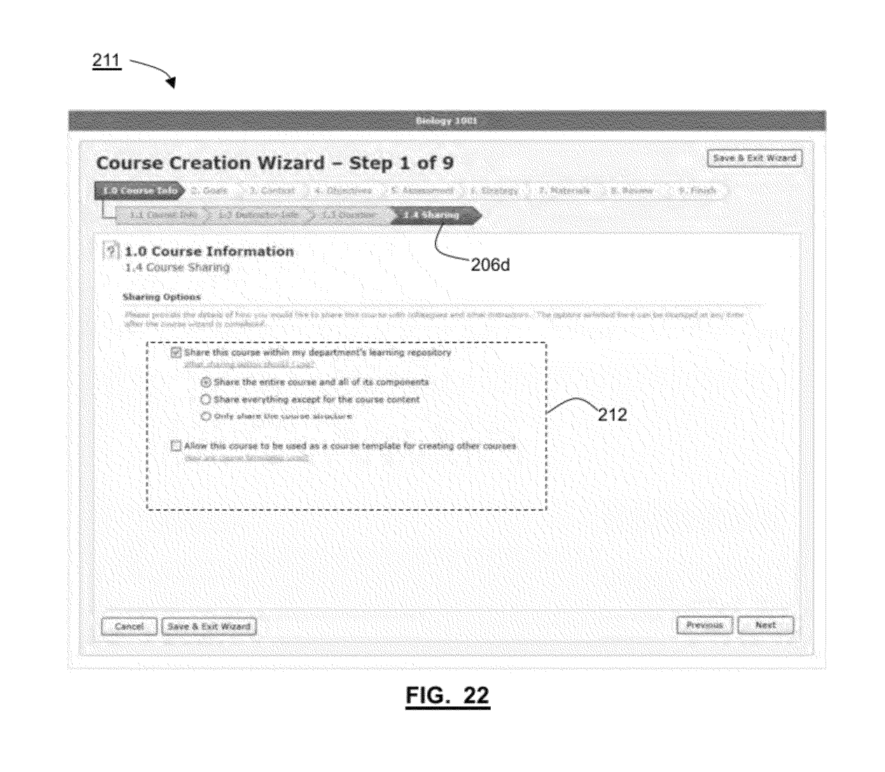

The next page in the course design module 200 may be a course sharing page 211 as shown in FIG. 22 (with “sharing” 206d highlighted as the active sub-component).

The sharing page 211 may allow the user to share all or parts of the course and/or its components within a learning repository where it can be accessed by other users who are creating courses. For example, a content area 212 may provide various controls for allowing the user to select whether to share the entire course, everything except the course content, or just the structure of the course.

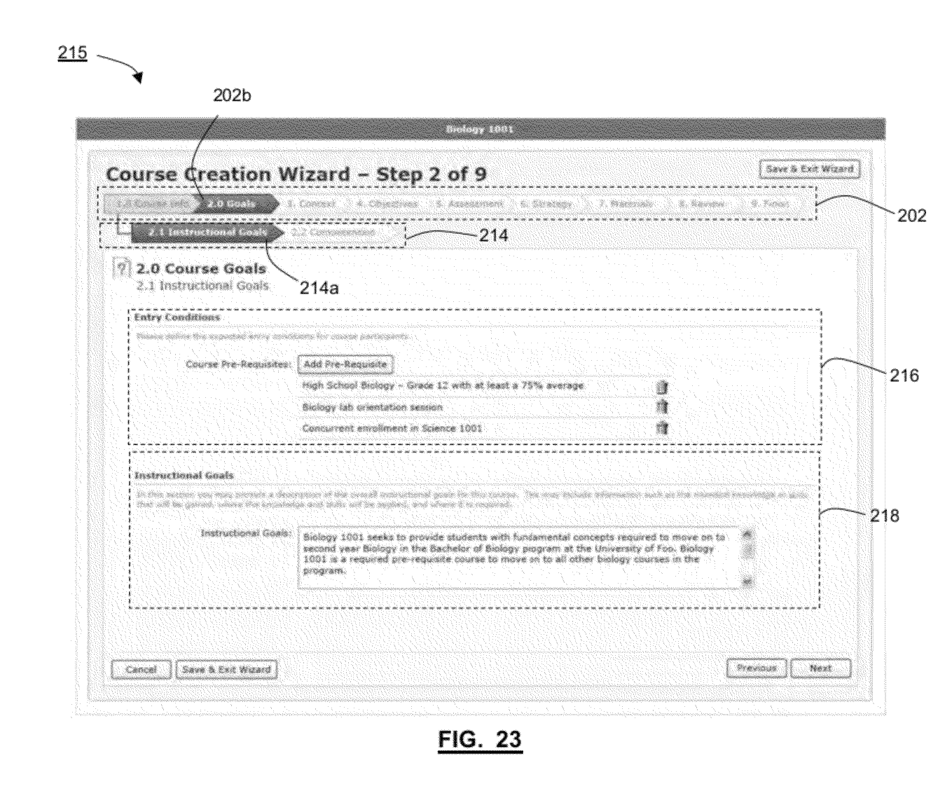

Turning now to FIG. 23, a goals 206b course component is presented on an instructional goals page 215 (with “instructional goals” 214a highlighted as the active sub-component 214 of the broad component “context”). The goals page 215 may allow the user to add broad goals for the course, including adding course pre-requisites using natural language objects and controls as shown in the first content area 216 (e.g. course participants must have completed high school biology with a 75% minimum average, must have attended a lab orientation session, etc.) and instructional goals using natural language objects and controls shown in the second content area 218 (e.g. “Biology 1001 seeks to provide participants with the skills to move on to a second year biology course”).

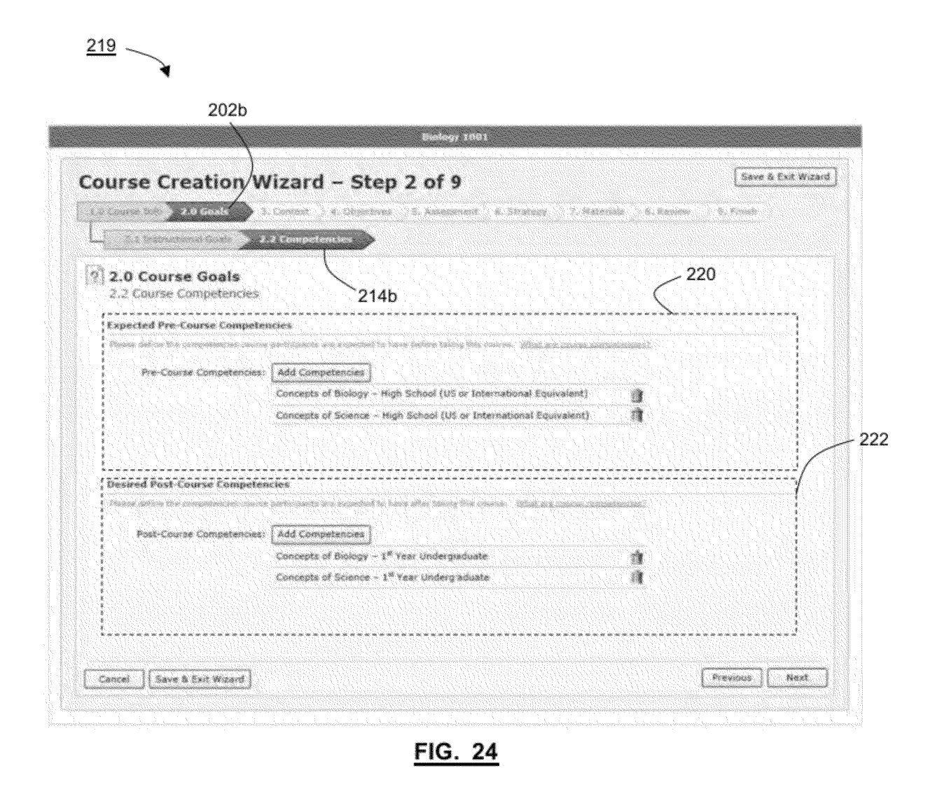

The user can then also add one or more course competencies, using the course competencies page 219 shown in FIG. 24 (with “competencies” 214b highlighted as the active sub-component 214). For example, pre-course competency requirements can be added using controls in a first content area 220 (e.g. the participants must have completed high school biology and high school science), while desired post-course competencies can be added using controls in a second content area 222 (e.g. participants must understand first year science concepts).

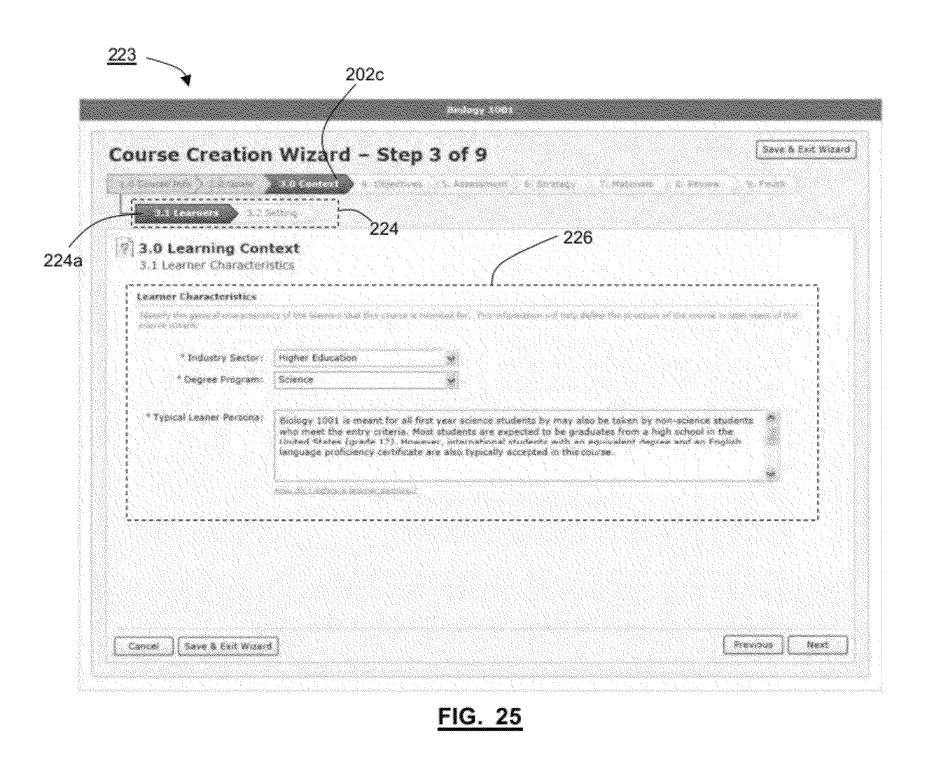

Next, the user may be presented with a learner characteristics page 223 as shown in FIG. 25 (with “learners” 224a highlighted as the active sub-components 224). This page 223 may allow the user to define the general characteristics of the participants in the course as presented in the content area 226, which may be used to modify subsequent course parameters that are presented to the user. For example, the course parameters for this course component could include prompting the user to identify elements such as industry sector (e.g. higher education, corporate learning, personal study, etc.), the type of degree offered (e.g. science, arts, etc.) as well as define a typical participant or learner persona.

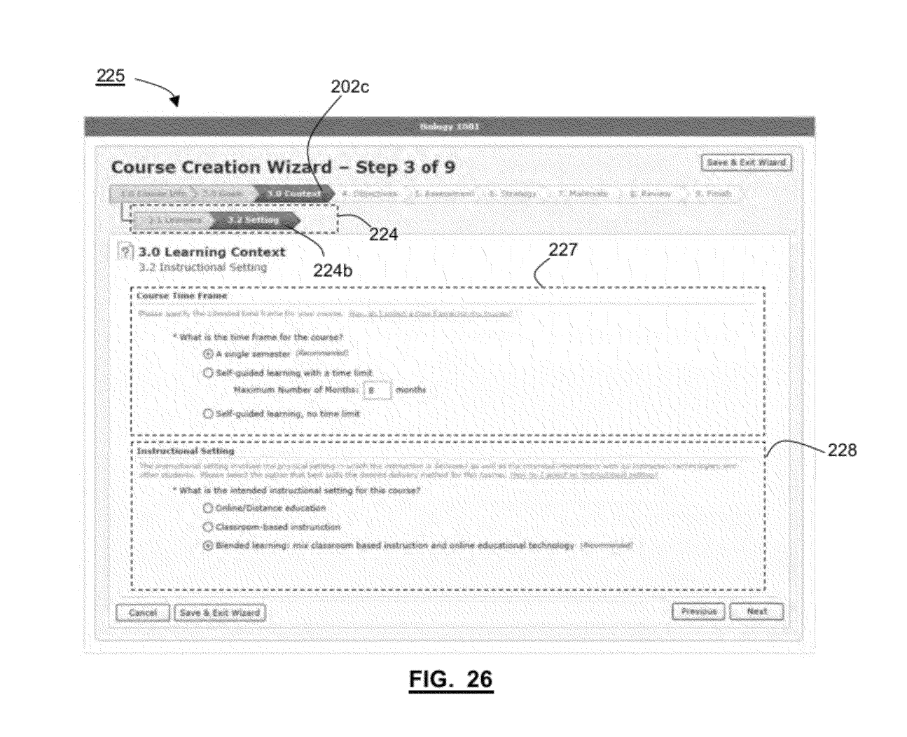

In FIG. 26, various elements of the learning context course component 202c may be further developed using an instructional setting page 225 (with “setting” highlighted as the active sub-component 224). For example, course parameters related to the course time frame may be presented in a first content area 227 (e.g. is this a single semester course, a self-guided study course with or without a time limit, etc.), while course parameters related to the instructional setting may be presented in a second content area 228 (e.g. is the course an online-only course, a classroom only course, or a blend).

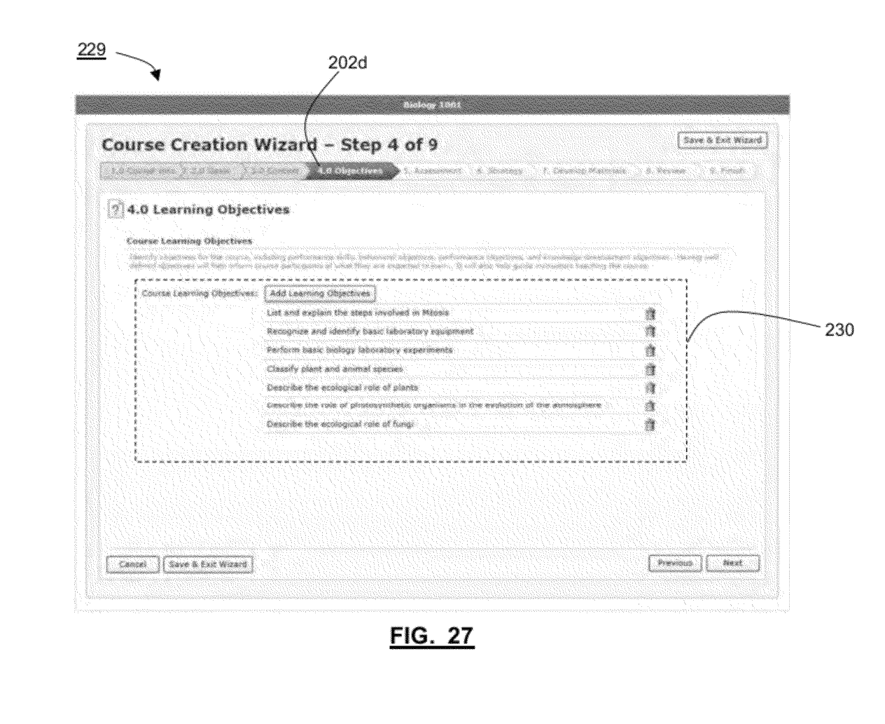

Turning now to FIG. 27 a learning objectives page 229 for the course component “objectives” 202d can be presented. The user can use the objectives page 229 to add and/or remove learning objectives for the particular course, which can include performance skills, behavioural objectives, performance objects, knowledge development objectives, etc. For example, one objective could be to recognize and identify basic laboratory equipment. These course parameters could include natural language objects (e.g. text) and controls (e.g. add or remove buttons) presented in a first content area 230.

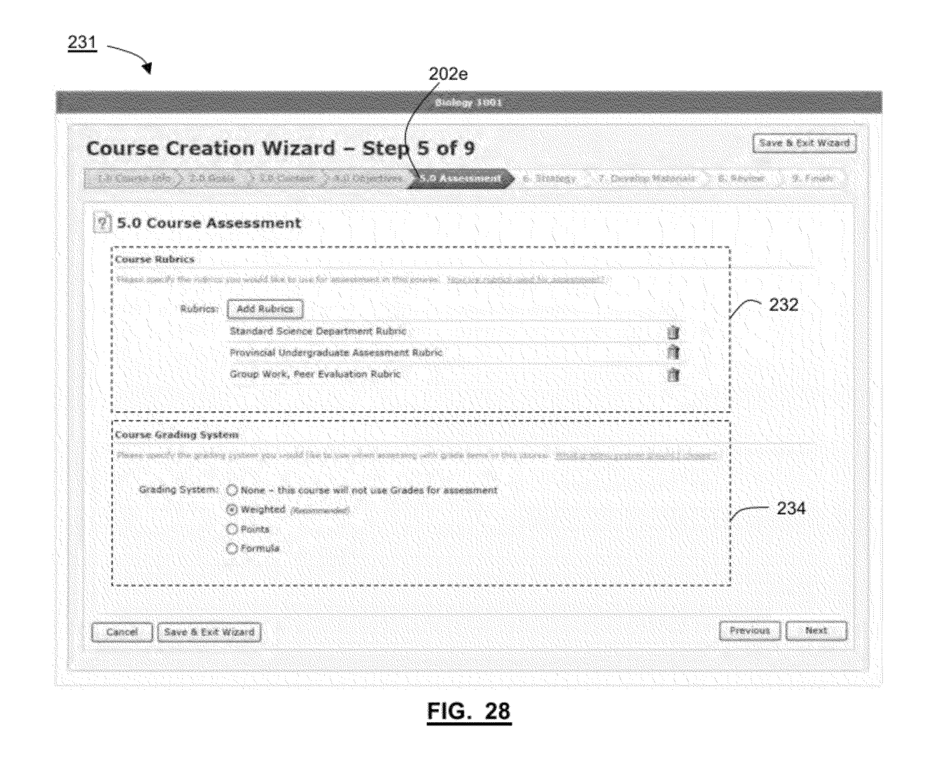

Once the learning objectives have been identified, a course assessment page 231 may be used to add assessments for the course, and (as shown in FIG. 28) for the course component “assessment” 202e.

The assessment course parameters could include course rubrics as shown in the first content area 232 (e.g. standard science department rubrics, provincial or state-wide rubrics) and selecting a grading system using a second content area 234 (e.g. weighted, points, formula, or no grading).

The next steps in the course design module 200 could include pages covering a “strategy” 202f course component. For example, FIG. 29 shows a course structure page 237 where parameters related to the course structure can be displayed in a content area 238 (with “structure” 236a listed as the active sub-component 236). In some embodiments, the content area 238 may include a suggestion 239 to the user based on previously received user information. For example, the course design module 200 may suggest that the user select a “science” course structure, and may actually place this suggestion as the default entry in one of the controls 241. The user can then use the controls 241 to select this suggestion or make another selection.

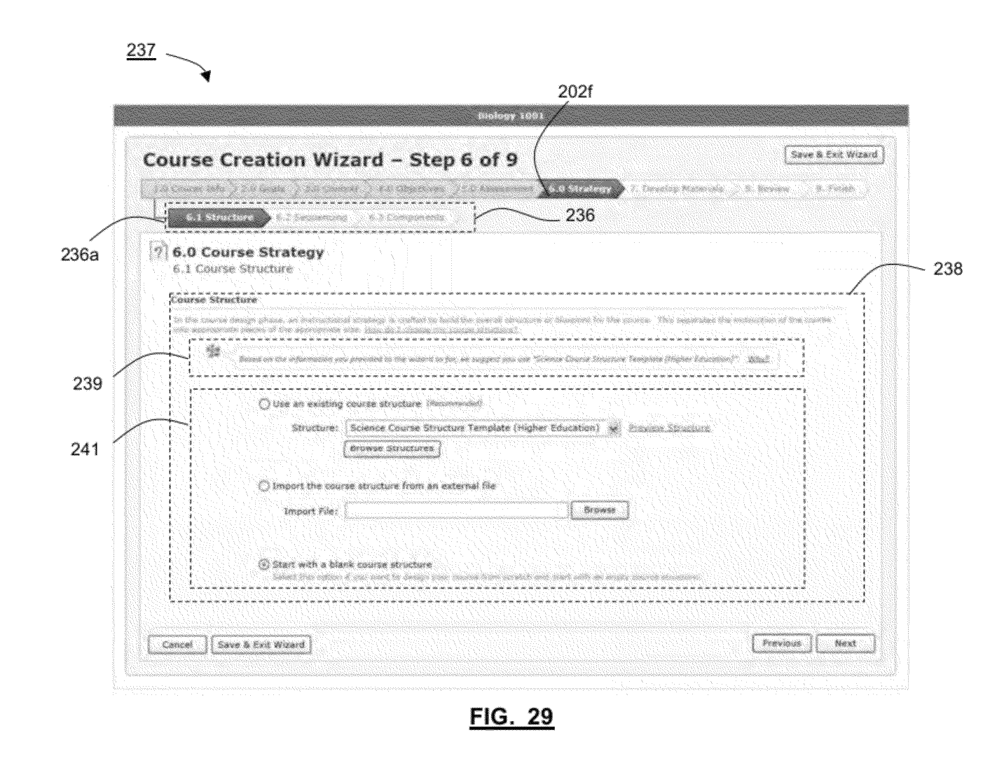

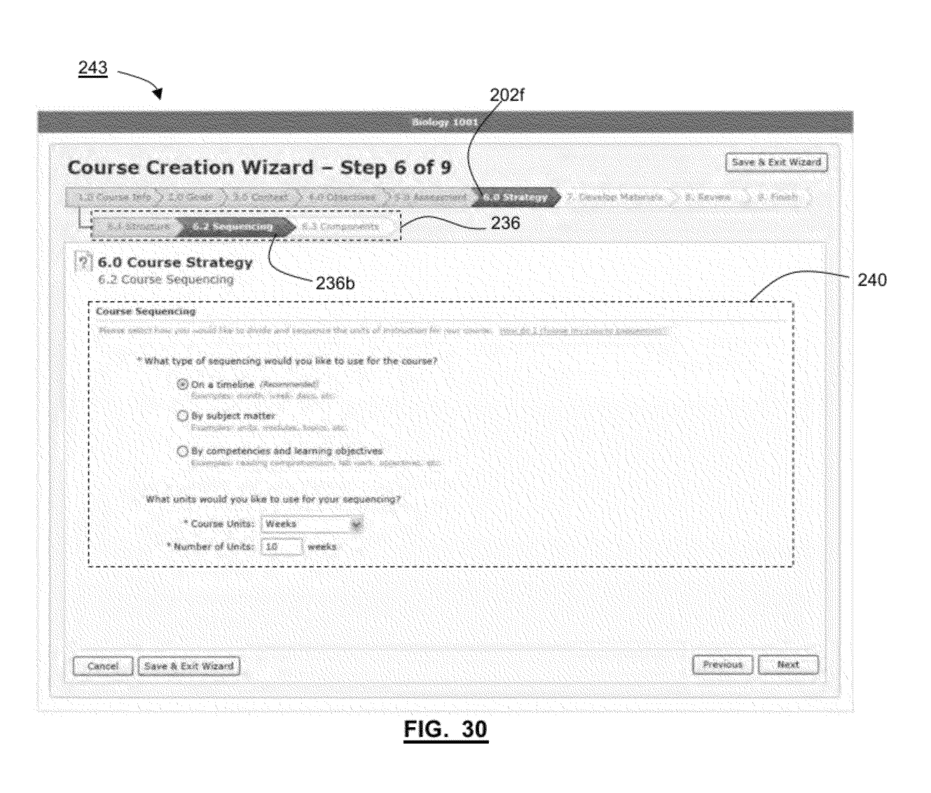

FIG. 30 shows a course sequence page 243 for the “strategy” 202f course component, which allows the user to modify course parameters related to the “sequencing” 236b sub-component of the course. For example, the user can use control in the content area 240 to select a sequence based on timeline, subject matter, or competencies, as well as define course units.

Furthermore, using a course components page 245 shown in FIG. 31, the user may be presented with suggestions 242 for educational components and features to be added to the course (e.g. one or more of a blog, discussion, dropbox, FAQ, etc.), and which may be presented in a content area 247 so that they may be selected or deselected by the user.

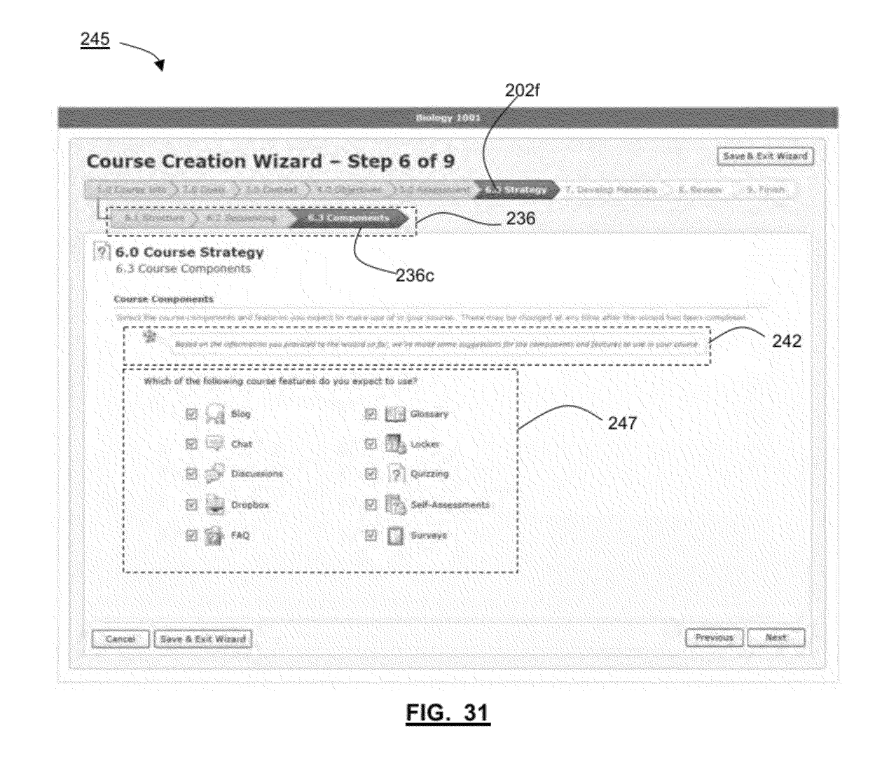

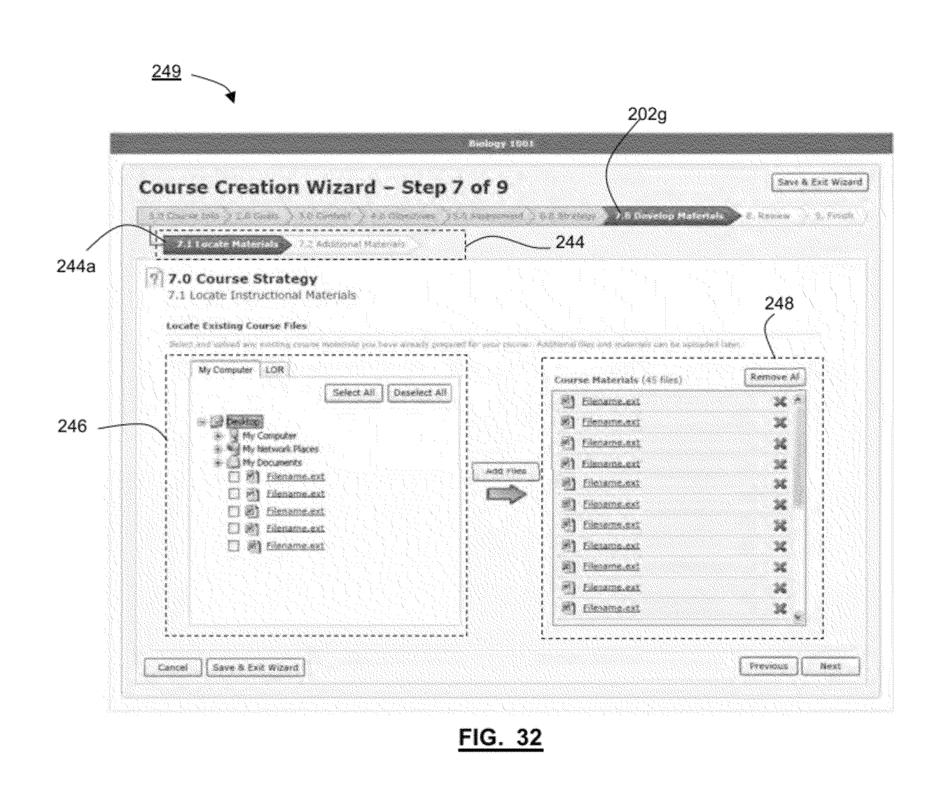

Turning now to FIG. 32, a locate materials page 249 for the course component “develop materials” 202g is shown (with “locate materials” 244a highlighted as the active sub-component 244). The locate materials page 249 will allow the user to input course materials (e.g. handouts, slides, audio recording, readings, etc.) that have been prepared for use with the course. The course materials may be selected by using a first content area 246 to browse a file system to locate files (which could be on a local drive or on a network). The user can then select particular files and add them to the course materials list as shown in the second content area 248.

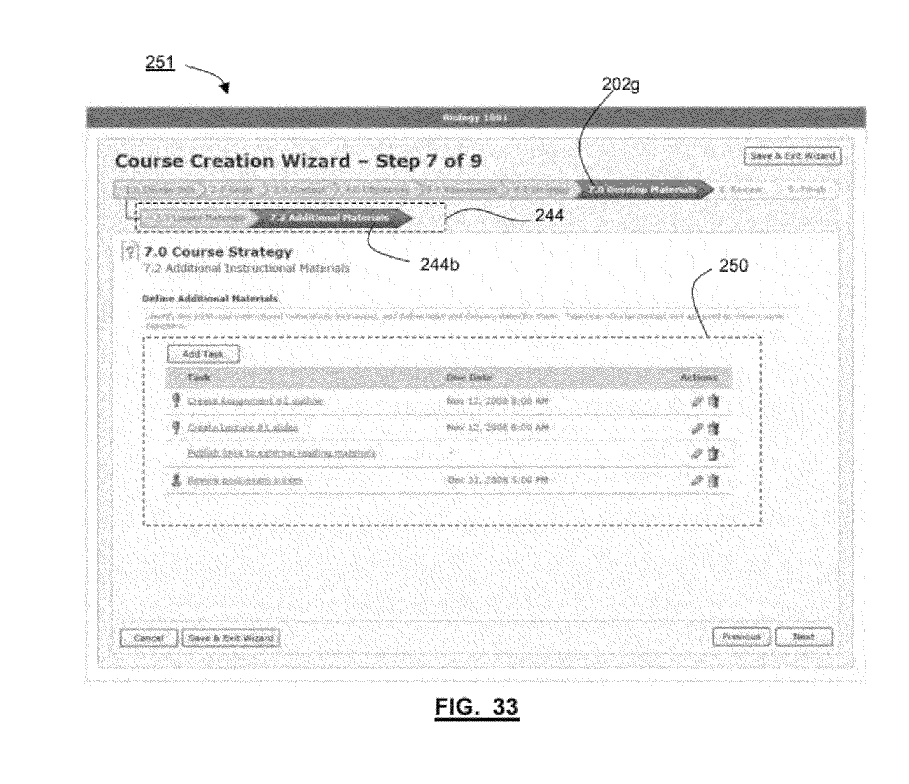

In some embodiments, the next step will be to provide additional materials using a define additional materials page 251 as shown in FIG. 33 (with “additional materials” 244b identified as the active sub-component 244). For example, natural language objects and controls in a content area 250 can allow the user to identify additional instructional materials to be created, define tasks (e.g. create lecture #1 slides), and set deadlines for completion.

In some embodiments, the next step is to define course review components 202h, for example using a course review page 253 as shown in FIG. 34. Using this page 253, the user can add one or more users to review the course that is being created (e.g. using controls in a content area 252), which may be helpful in ensuring that the user creates a course that meets the requirements of the particular educational institution.

Turning now to FIG. 35, the user has completed the course design module 200 and is presented with a completion screen 255 (with “finish” listed as the active course component). Using controls in the content area 254, the user can then choose to take actions such as previewing the course, editing the course using the course design module 200 or another application, etc.

The course design module 200 can therefore generate a customized course framework that is based on the course parameters presented to the user and the inputs received from the user.

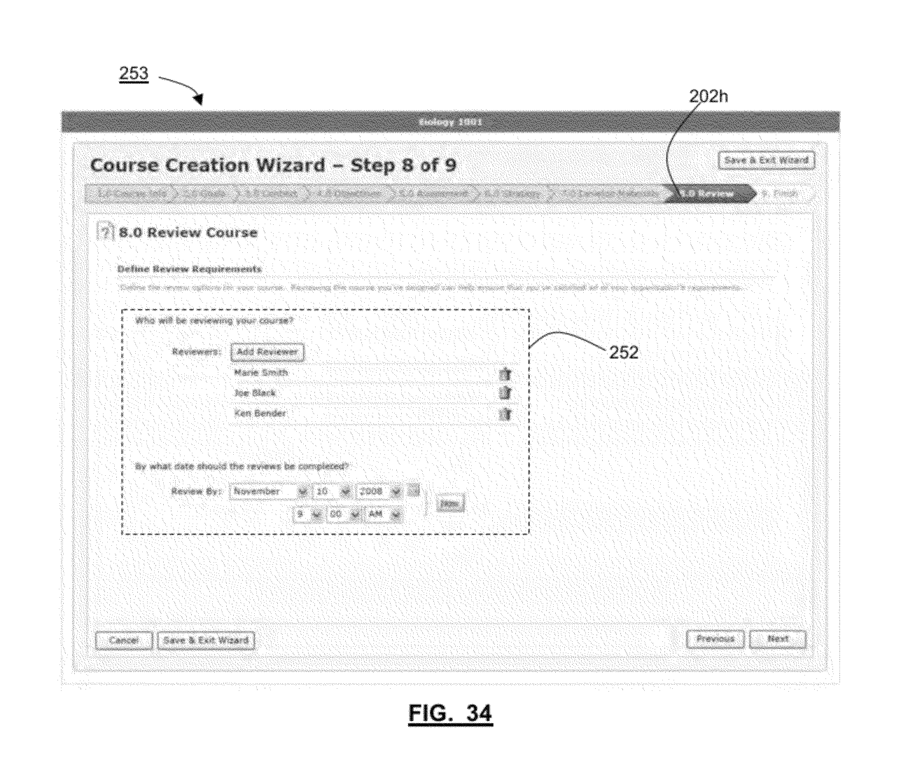

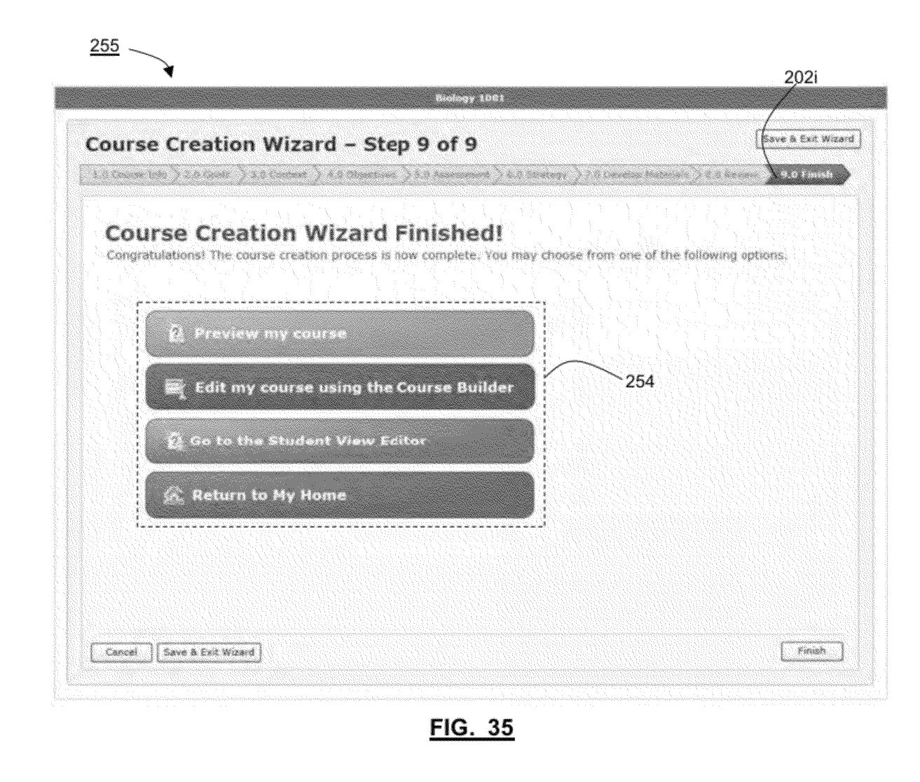

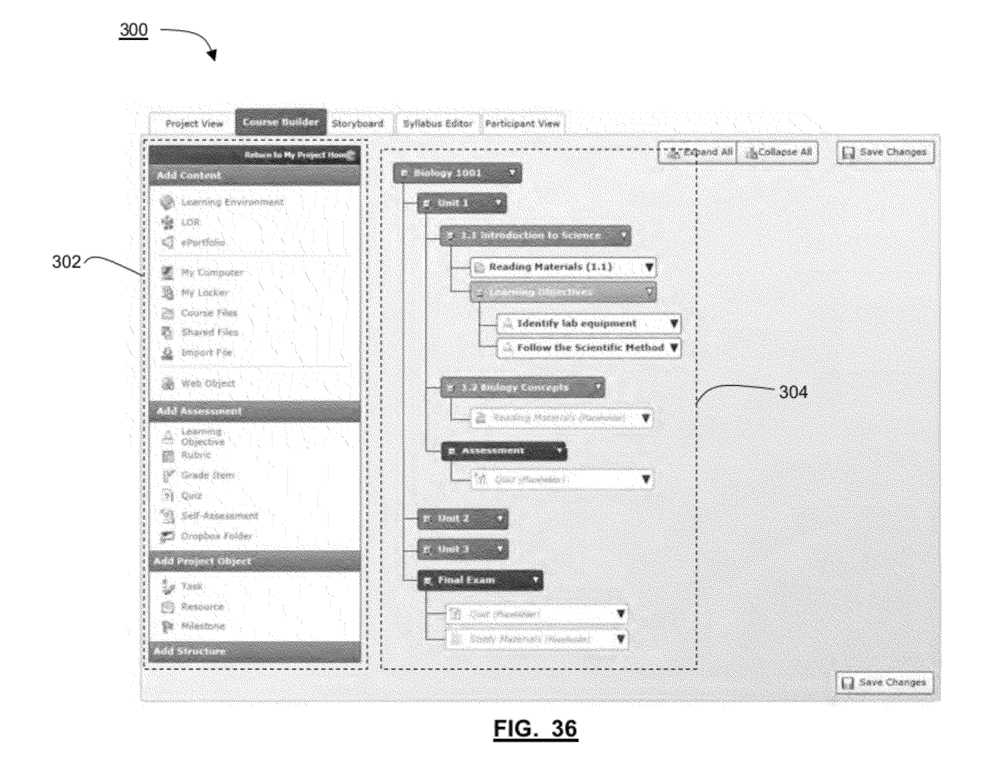

Turning now to FIG. 36, illustrated therein is a course builder module 300 for displaying customized course framework information 304 according to one embodiment. As the course builder module may include a menu area 302, which may allow one or more users to take various actions with respect to the customized course framework 304, such as add content (e.g. files, web objects, etc.), add assessment (e.g. learning objectives, rubrics, quizzes, etc.) and add project objects (e.g. tasks, resources, etc.).

As shown, the course framework 304 is generally presented as a tree structure, as will be described in detail below.

FIG. 37 is a detail view of the course framework 304 according to one embodiment, labeled generally as 304a.

In this embodiment the course framework 304a includes a course title 306 (e.g. Biology 1001), a plurality of units 308a, 308b, 308c, and a final exam 310. Each unit 308a, 308b, 308c may include sub-elements. For example, the first unit includes two instructional elements 312a (labeled “introduction to science”) and 312b (labeled “biology concepts), and an assessment 314.

The first instructional element 312a includes reading materials 316, and two learning objects 318, namely “identify lab equipment” 318a and “follow the scientific method” 318b.

The second instructional element 312b includes a placeholder for reading materials 317 (and which may be populated with actual reading material content at a later time).

The assessment 317 also includes a placeholder for a quiz 319.

The final exam 310 includes two placeholders for a quiz 319 and for study materials 321.

By presenting the customized course framework 304 in this manner, users can quickly grasp the overall structure of the course, which may be useful in organizing the course material and identifying materials that still need to be created. For example, in some embodiments, the placeholders can be populated with elements using the course builder 300, and/or one of the course design modules 100, 200 identified above.

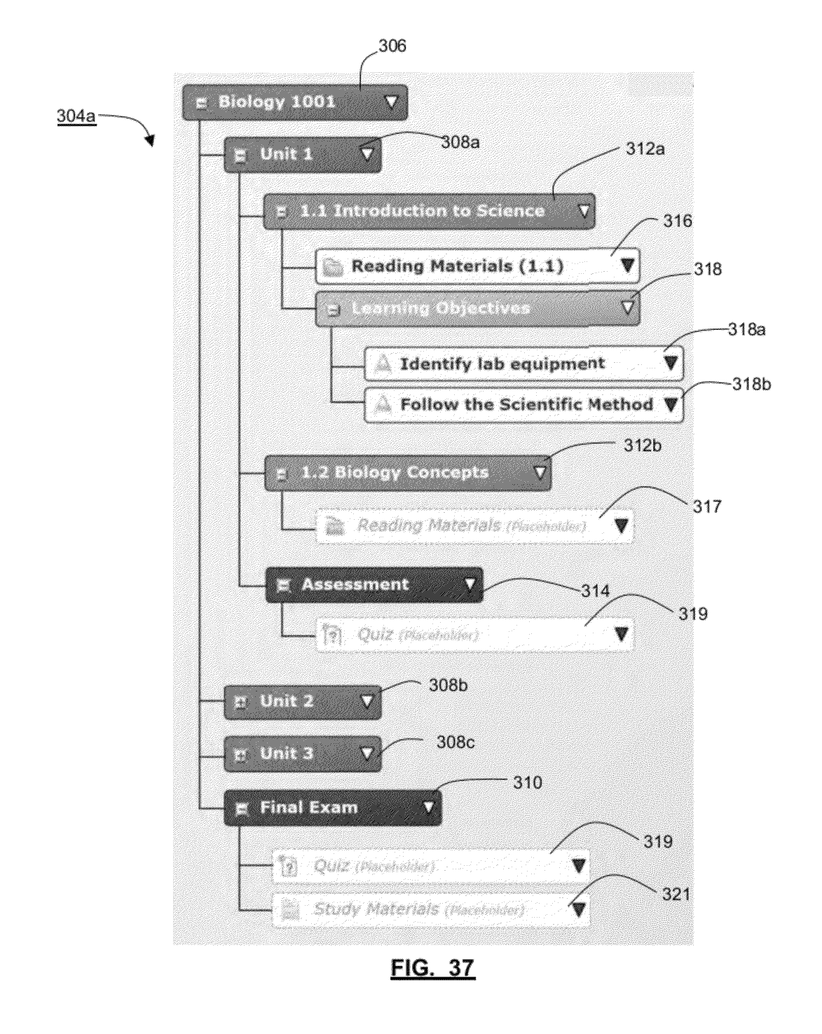

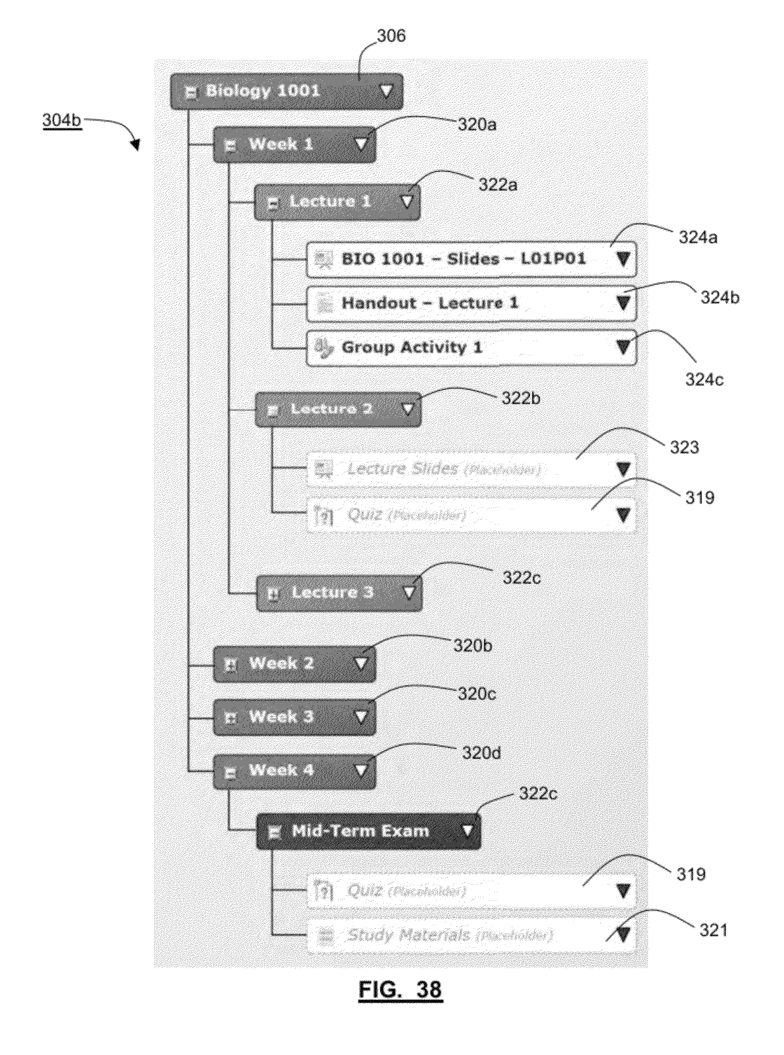

The course framework 304 may also be presented in different ways to facilitate understanding of the course structure. For example, as shown in FIG. 38 the course framework 304 for the same course may be shown according to another embodiment labeled generally as 304b.

In this embodiment, the customized course framework 304b is presented in a generally chronological order, with four weeks 320a, 320b, 320c, and 320d being identified. Each week 320a, 320b, 320c, 320d can have one or more educational elements associated therewith.

For example, the first week 320a includes a first lecture 322a and a second lecture 322b. The first lecture 322a includes slides 324a, a handout 324b and a group activity 324c associated therewith.

The second lecture 322b has placeholders for slides 323 and a quiz that have yet to be populated.

The fourth week 320d includes a mid-term exam 322c, which as shown includes placeholders for a quiz 319 and study materials 321 that have yet to be populated with content.

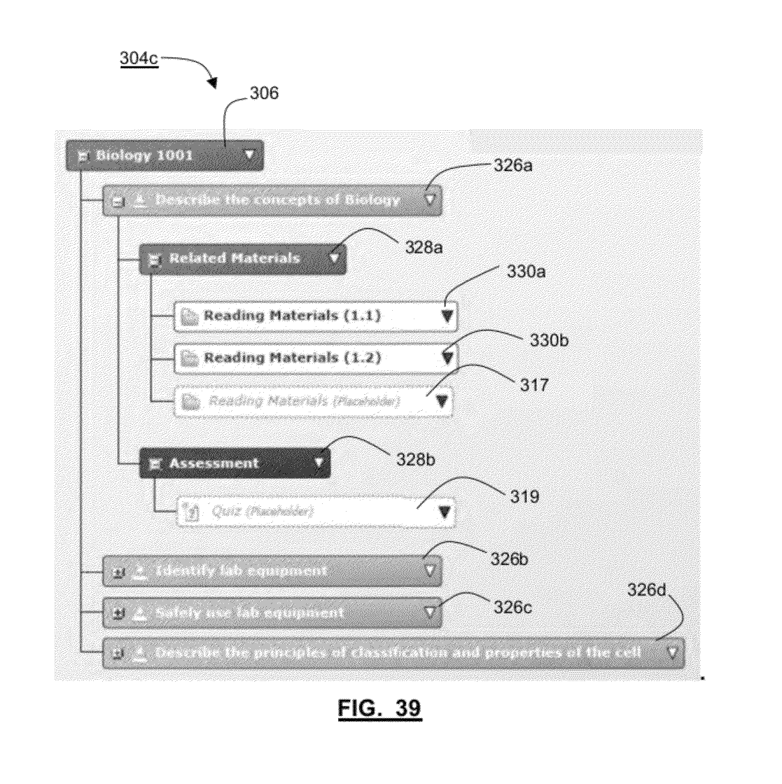

FIG. 39 shows yet another view of the course framework 304 indicated generally as 304c according to yet another embodiment. In this embodiment, the course framework 304c is presented according to course objectives. For example, a first course objective 326a (“Describe the concepts of Biology”), a second course objective 326b (“Identify lab equipment”), a third course objective 326c (“Safely use the lab equipment”), and a fourth course objective 326d (“Describe the principles of classification and properties of the cell”).

The first course objective 326a includes general reading materials 328a, and an assessment 328b. The general reading materials 328a include specific reading materials 330a, 330b (e.g. particular chapters in a text book) as well as a placeholder 317 for additional reading materials.

The assessment 328b includes a placeholder 319 for a quiz.

Generally, in some embodiments, each of the course components and/or course parameters may be selected to be presented to a user based on educational theory. In some embodiments, educational theory may include research literature, expert opinions, and/or various other materials related to the field of teaching and knowledge acquisition more generally.

In some embodiments, a user providing input to one or more course parameters may be presented by providing educational theory in an understandable format (e.g. natural language) at the point of decision by the user. As such, the user may consider selected relevant educational theories when making one or more decisions as to the selection of particular educational elements for the course.

As noted above, some of the users 12, 14 may be instructors and some of the users 12, 14 are learners. In some embodiments, some users 12, 14 may be both instructors and learners.

The description herein provides examples wherein the instructors are primarily responsible for designing one or more educational courses that are provided to the learners. However, it should be understood that in some embodiments, educational courses may be designed by users other than the instructor of a particular course (for instance, teaching assistants or administrators may also assist in designing a particular course, or courses may be designed by third party content designers or publishers).

In some embodiments, the instructors may receive guidance from a governing or accreditation institution as to one or more topics of instruction and competencies that a learner should have achieved after successfully completing a particular course. In such embodiments, the instructors may develop the course with a view to help the learners develop such competencies when the learner completes the course.

For example, a school board may require that students who has completed a primary school class on mathematics to be able to perform simple arithmetic. In such a case, the instructor may develop the course as he or she sees fit, provided that the learners for that course obtain the desired competencies upon the successful completion of the course.

In particular, each educational course may have a set of competencies that a learner completing the course is expected to have upon successful completion of the course, and the competencies may differ from course to course. For example, a competency for a math class may be basic arithmetic while a competency for a history class may require that the student be familiar with certain information about the civil war.

In some embodiments, one or more learning objectives for a course may be defined based on the desired competencies. Each learning objective may be associated with a topic of instruction that is related to or associated with the competencies for that course such that, if a learner meets those learning objectives, he or she is likely to have the desired competencies for that course.

In some embodiments, one or more of the learning objectives may be defined based on input from the instructor. In other embodiments, one or more the learning objectives may be defined without input by the instructor (for example, learning objectives may be developed by a governmental organization, accreditation facility, or an institution's administration). In some embodiments one or more learning objectives may be determined based on existing courses and suggested to the instructor.

Generally, each educational course may have a number of content modules and assessment modules. Each content module contains educational material about a particular topic. For example, a specific content module may include textbooks (or relevant excerpts or readings therefrom), audio recordings, video recordings, articles, or generally any source of information on that topic so that when the content module is consumed by the learner, the learner is exposed to selected information about that topic (and hopefully will retain some knowledge about that topic).

Most courses also include assessment modules that are designed to assess the learner's knowledge about one or more given topics. For example, an assessment module may include one or more quiz questions, essay topics, multiple-choice questions, oral assessments, and so on.

In some embodiments, a course may not include an assessment module. For example, a course may be offered on an “auditing” basis such that no assessment need be completed.

Generally, the instructor may organize the content and assessment modules in various ways. For example, the instructor may design and structure the course such that the system 10 provides the components of the course to the learner in a certain order.

In some embodiments, a course design module may be adapted to help facilitate the creation of a pedagogically sound course having one or more pedagogically sound learning modules.

In some embodiments, the order of presentation or organization of the content modules and assessment modules may not necessarily be based on the particular learning objective. That is, the instructor may design the course such that an electronic learning system provides or presents the components of a course in some particular order and structure, and need not provide the modules related to a given learning objective together.

For instance, in a history class, the instructor may wish to provide the content modules to the learners in a generally chronological order. For example, a course on the civil war may be presented chronologically rather than on a particular learning objective basis (e.g. as opposed to organizing the course based on learning objective on Abraham Lincoln or the Gettysburg address).

In another example, in a mathematics class, the instructor may organize the content modules such that they are presented in discrete logical groups of increasing conceptual difficulty. For example, the instructor may wish to organize the course such that addition is normally taught before multiplication, and multiplication is taught before division.

Depending on the manner in which assessment modules are organized and presented, a learner's performance for a specific learning objective may be not be readily available without additional data processing. For example, if the assessment module includes a number of multiple choice questions for a number of content modules then the learner's performance in each of the content modules may not be readily available.

Generally, curriculum development for a course requires instructor resources in that it is necessary for the instructor to spend time and effort to aggregate content modules and assessment modules to meet the learning objectives for the particular course. To reduce the resources required to prepare the course, the instructor may try to look for precedents (e.g. a course that has been previously developed that covers at least some of the learning objects, or learning content that relates to at least some of the learning objects, such as sub-units or modules within a course). For example, if the instructor has developed a course for similar learning objectives for a previous term, the instructor may “recycle” the previously prepared curriculum by using that previous curriculum as a starting point. This may be effective when there are significant similarities in the type and scope of learning objectives between the course that was prepared previously and the course that the instructor is currently developing.

However, in cases where there are few similarities in the learning objectives, the previously developed course will not be nearly as useful, and instructors would often need to substantially rework the previous course materials to derive any benefit therefrom.

In particular, the instructor may need to spend significant resources amending the content and/or assessments that were provided in the precedent to remove materials that are not relevant to the current course and add materials that are relevant. This may require the instructor to carefully examine each component of the precedent and determine whether it should be kept, replaced or reworked. For example, if the assessment modules comprise a plurality of questions on a plurality of content modules, the instructor will normally need to go through the assessment modules on a question-by-question basis to remove the ones that are not “supported” or relevant to the content that is being provided in the current course.

However, some embodiments described herein attempt to assist the instructor in course design. In particular, embodiments described herein allow the instructor to generate learning modules based on a given learning objective. The learning modules normally include one or more content modules and assessment modules that are associated with that learning objective. Because the embodiments allow for the instructor or other course designer to associate the learning modules with a specific learning objective, the learning modules can then be reused during subsequent course development based on that learning objective.

In particular, each learning module may be defined independently. That is, the learning module may be formed based on a given learning objective and is generally independent from how the content modules and/or the assessment modules are organized and presented to the learners. As such, the learning module permits alignment of the components of a course with each learning objective, regardless of how the course components are organized and presented to the learners. This allows the learning modules to be easily reusable during subsequent course design, as a course instructor or designer can begin building their course by selecting specific learning modules based on the specific learning objectives they would like to include in their course.

Referring now to FIG. 40, illustrated therein are components of an exemplary course 330 according to some embodiments. The course 330 may be designed, at least in part, using one or more of the course design modules and/or systems as described herein.

The course 330 is logically organized into two course units, namely Unit 1 and Unit 2 as indicated by reference numerals 332 and 334. In this embodiment the course units 332 and 334 this course divides the course to two-terms. In other embodiments, there may be a different number of course units and they may be organized differently. For example, the course may be organized so that each course units correspond to a chapter, a topic, and so on.

As shown, each of the units 332, 334 comprises a plurality of content modules and assessment modules. In particular, Unit 1 includes content modules C0, C1, C2, C3 and assessment modules A1 and A2 in a mid-term assessment 336. Unit 2 includes content modules C4 and C5, an informational assessment 338, and end-of-term assessment 340. The informational assessment 338 includes informational assessment modules Ai1, Ai2, and Ai3, and the end-of-term assessment 340 includes assessment modules A5 and A6.

In various embodiments, and depending on the course design, the numbers of units, organization and the content of each of the unit, number of content modules, and number of assessment modules may differ.

Each of the content modules includes educational material about a specific topic. For example, the content modules may include textbooks, articles, research papers, multimedia content such as audio data, video data, or any other forms of educational material. In some embodiments, the content module may provide the educational material over the Internet 28 (e.g. via a web page). In some embodiments, the content module may include references to physical textbooks that the learners may access.

The assessment modules may include various ways to assess the learner performance in the course. For example, the assessment modules may include multiple-choice questions, short-answer questions, long answer questions, research topics for essay-type answers, verbal evaluations, presentations, etc.

The course 330 is designed to achieve four learning objectives, namely LO1, LO2, LO3, and LO4 indicated generally by reference numeral 341.

In the embodiment as shown, each of the learning objectives 341 is associated with one or more of the content and assessment modules. In some embodiments, this association may be made based on semantic alignment between the learning objectives LO1, LO2, LO3, and LO4 and the content and assessment modules. For example, if a particular learning objective is about arithmetic, the content modules that are associated with that learning objective may be related to addition, subtraction or other arithmetic operations. Similarly, the assessment modules that are related to the learning objectives may be directed to assessing the learner's understanding of that particular learning objective(s).

In some embodiments, the association between the learning objectives LO1, LO2, LO3, and LO4 and the content and assessment modules is made based on input received from the instructor. In other embodiments, the associations may be made automatically for example, based on how the course is organized, governmental or accrediting facility guidelines, and so on.

As shown, in this embodiment the first learning objective LO1 is associated with content module C1, and assessment modules Ai1 and A5. The second learning objective LO2 is associated with content modules C2 and assessment modules A2, Ai2, and A5. The third learning objective LO3 is associated with content modules C3, C4 and assessment modules Ai3, A6. Finally, the fourth learning objective LO4 is with content module C5. Generally the associations between the learning objectives LO1, LO2, LO3, and LO4, content modules and the assessment modules define learning modules.

In other embodiments, the number of content modules and/or assessment modules that are associated with each learning objective may differ.

In some embodiments, learning modules may be created by storing the association between the learning objectives and one or more content modules and assessment modules in a data storage device. For example, the association between the components may be recorded as metadata associated with one or more of the components.

In some embodiments, each learning module may include instances of one or more content and assessment modules such that the learning modules are self-contained.

In some embodiments, there may be content modules that are provided in a course but are not associated with any learning objective. For example, as shown in FIG. 40, content module C0 may not be associated with any particular learning objective. The content C0, for example may be an introductory chapter or some other educational material that may not be relevant to any of the learning objects of the course 330.

Referring now to FIG. 41, illustrated therein are exemplary learning modules 342, 344, 346, 348 that are formed from the association shown in FIG. 40. Learning module 1 includes the first learning objective LO1 and associated content module C1, and assessment modules Ai1 and A5. Learning module 2 includes the second learning objective LO2 and associated content module C2, and assessment modules A2, Ai2 and A5. Learning module 3 includes the third learning objective LO3 and associated content modules C3 and C4, and assessment modules Ai3 and A6. The learning module 4 includes the fourth learning objective LO4 and associated content module C5.

In some embodiments, the learning modules may be published to a learning module repository where other instructors may subsequent access these modules, such as by using a search engine or by browsing through the repository. That is, the learning modules could be stored on a data storage device and subsequently be made available to other users designing other courses or otherwise searching for learning modules. This allows the learning modules to be reused, which can facilitate the development of other courses.

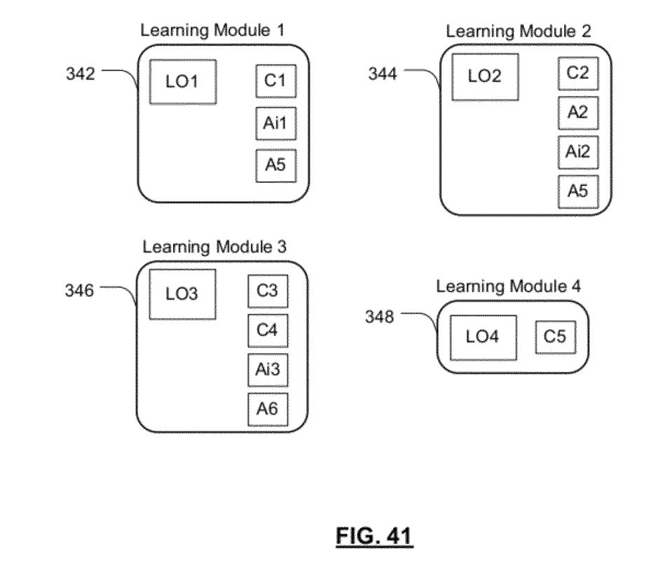

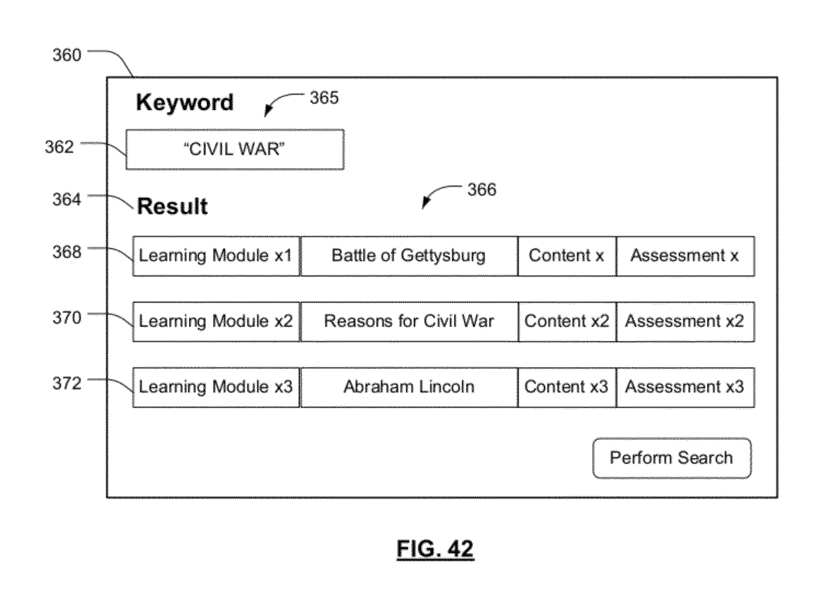

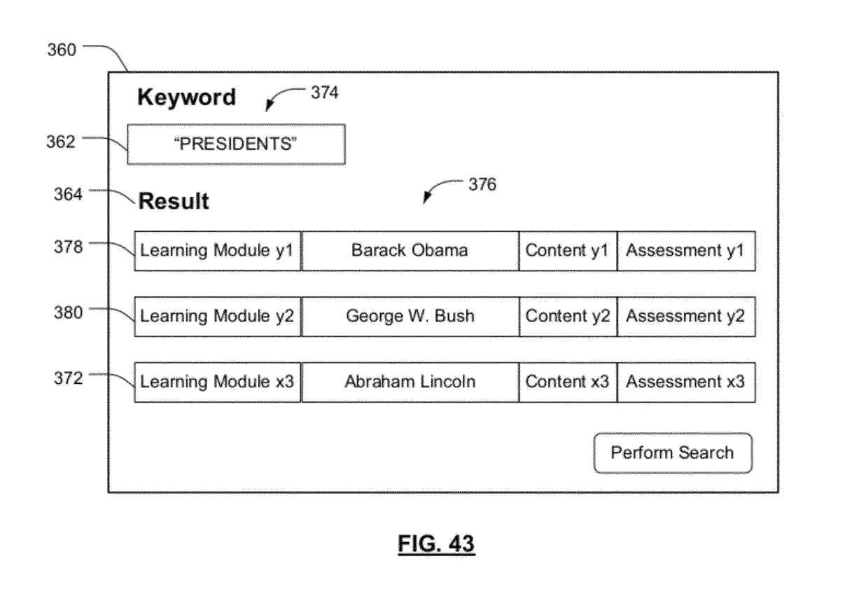

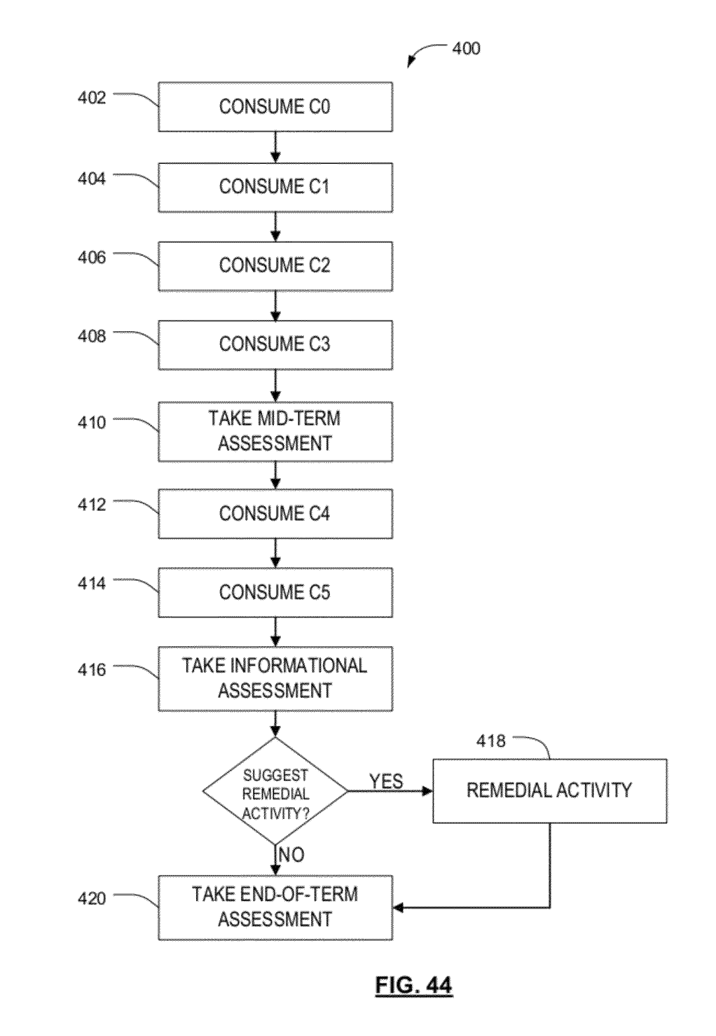

Referring now to FIG. 44, illustrated therein is a block diagram 400 illustrating an example of how the learner may interact with the course 330. The learner would start at block 402 where the learner consumes the content module C0. The learner would proceed to blocks 404, 406, 408 whereby content modules C1, C2, C3 are consumed. In some embodiments, the learner may consume the content modules in a different order, particularly in an electronic learning system such as the system 10. For example if the instructor did not specify that the content modules should be consumed in a particular order (e.g. C0 before C1, C1 before C2, C2 before C3 and so on) the learner may consume the content modules in any order that he or she chooses.

In some embodiments, one or more of the content modules may be optional.

After consuming the content modules C0, C1, C2, and C3 in Unit 1, the learner may then take the mid-term assessment 336 at block 410. In some embodiments, the course 330 may be configured such that the learner is not permitted to proceed to Unit 2 unless the midterm-assessment 336 has been successfully completed.

After completing the modules in Unit 1, the learner may proceed to Unit 2 whereby the learner consumes content modules C4 and C5 at blocks 412 and 414.

At block 416, the learner completes the informational assessment 338. The information assessment 338 may be adapted to identify the learner's strengths and weaknesses of the various components of the course. In some embodiments, performance of the learner on the informational assessment may not be graded or recorded as part of the overall evaluation of the learner's performance in the course.

Depending on the performance of the learner on the informational assessment 338, the learner may be suggested (e.g. using a recommendation engine) to perform a remedial activity at block 418.

In some embodiments, the type of remedial activity may be determined based on the performance of the learner on one or more particular assessment module (or components thereof) of the informational assessment 338. For example, if the learner performed poorly on assessment module Ai1, then the learner may be directed to review content module C1 which is associated with the Ai1 through LO1. Similarly, the learner may be directed to review C2 if his/her performance was poor on Ai2, and C3 and C4 if the performance was poor on Ai3.

In some embodiments, a recommendation engine may be implemented to determine one or more remedial activities that should be suggested to the learner. The recommendation engine, for example, may conduct statistical analysis of the results of various assessment modules to determine whether some learners are particularly weak on certain assessment modules or on certain learning objectives (or both). Based on these results, the recommendation engine may identify remedial content modules that are associated with similar (or the same) as the learning content modules. In some embodiments, the recommendation engine may identify other learning content modules that may be more effective to teaching the learning objectives associated with the assessment module.

In some embodiments, new or supplemental content modules in additional to the existing content modules may be provided as remedial activity at step 418.

In some embodiments, remedial activities other than providing content modules may be executed. For example, the remedial activities may include the instructor or a tutor providing one-on-one guidance to the learner if he or she performs poorly on an assessment module associated with a particular learning objective.

In some embodiments, an informational assessment may be deployed prior to, at or near the start of the course, to test the learners for their competency in one or more learning objectives that the learner is expected to have achieved prior to starting the course 330. For example, in a grade 4 math class, an initial informational assessment may be deployed to incoming students to ensure they have a proper grasp of fractions, certain arithmetic operations, and so on. In such embodiments, the informational assessment may guide the learner to identify areas of weaknesses and direct them to “brush-up” or seek supplemental learning in those areas. In some embodiments, such informational assessment may be “recycled” from a prerequisite course.

In some embodiments, if the learner performs particularly well on the informational assessment (or another type of assessment), the learner may be provided with an option to participate in mastery activities (not shown). The mastery activities may include supplemental or other content modules that exceed the learning objectives so that more advanced learners are exposed to more challenging educational material which may help retain their interest in the course for example.

After providing the remedial activity in step 418, or if no further remedial activity is necessary, the learner then proceeds to block 420 where the end-of-term assessment may be administered.

Generally, associating the learning objectives with related content and assessment modules may provide certain advantages as described herein.

In some embodiments, assessments associated with certain learning objectives may be weighted differently from other learning objectives. For example, if it is decided that learning objective LO1 is more important than LO2, more weight may be assigned to the performance of the learner on LO1. As the assessment modules are associated with the learning objective it may be possible to assign such weighing without needing to analyze the mid-term assessment 338 or end-of-term assessment 340.

Additionally, as described above, the course may also provide informational assessment for identifying a learner's weaknesses on one or more of the learning objectives and to suggest related remedial activities.

Performance of the learners for that class may also be analyzed on a “learning objective by learning objective” basis. This may permit a review of the course to determine whether the learning objectives are being met effectively. For example, if the entire class performs poorly on a given learning objective, the instructor may wish to review and revise the content and/or assessment modules associated with the learning objective accordingly.

Associating learning objectives with related content and assessment modules may promote transparency and accountability. An observer would be able to determine relatively easily whether certain content module or assessment module is related to a given learning objective. In some instances, administrators for the course may also use such data to measure and monitor the effectiveness of particular instructors at teaching particular learning objectives.

Associating learning objectives with related content and assessment modules may also provide a learner with an option to consume these modules in a different order than in the order suggested by the organization of the course units. For example, the learner may consume the content and assessment modules according to the learning objective they are associated with, which might be different from how the instructor has organized the course using course units. In such cases, information about the associated units (e.g. chronological information) may be provided such that the learner may be given a sense of how these modules relate to other modules in the course.

In some embodiments, the learning modules may be published to a learning module repository where other instructors may subsequently access these learning modules. This allows the learning modules to be reused for developing other courses. As the learning modules in the repositories retain their associations to the content modules and assessment modules, these one or more content and assessment modules are also available for reuse by other instructors.

Moreover, since some learning modules are self-contained and comprehensive, they can make it easier for subsequent course design in that the learning modules can be added to a course and the course designer can be reasonably confident that the desired learning objectives will be met given the content and assessments included in each of these learning modules.

Furthermore, some learning modules may provide a pedagogically sound and comprehensive educational material on a specific learning topic (for e.g. by including sufficient content and assessment modules). If a new course is developed based on one or more pedagogically sound learning modules, the newly developed course is inclined to be pedagogically sound as its constituent learning modules are also pedagogically sound.

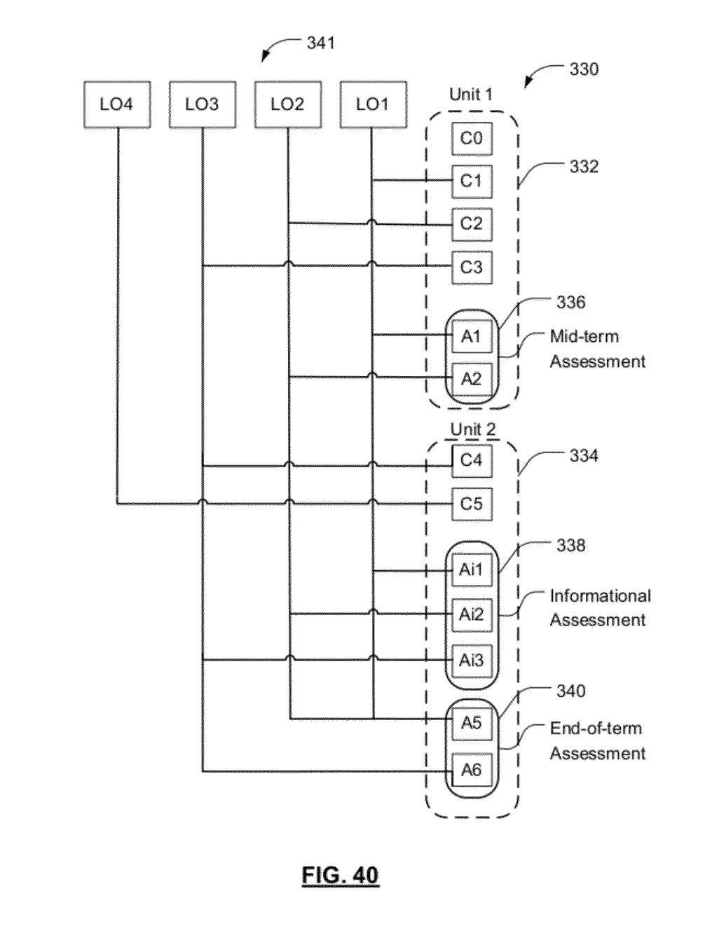

Referring now to FIGS. 42 and 43, illustrated therein is an exemplary search interface 360 that can be implemented to search for stored learning modules in a repository according to one embodiment. This type of search interface may be usable by someone who is developing a particular course with a set of particular learning objectives. In such cases, the interface may be used to search for specific pre-determined learning modules related to specific learning objective and which may include associated content and assessment modules.

This may reduce the resources required to develop a course, as the instructor may be able to develop the course by piecing together learning modules for each desired learning objective.

In contrast, in prior approaches to course design, relying on previously developed courses that do not associate the course components to the learning objectives may require much greater amount of time and effort by the instructor or course designer to identify specific components of interest of the course that are related to a desired learning objective.

As shown, the search interface includes a keyword field 362 and a result area 364 where resulting learning modules identified by a search engine (if any) may be displayed.

In FIG. 42, a keyword 365, namely “CIVIL WAR” is inputted in field 362 and several relevant learning modules 366 are returned as results. As shown, the generated learning modules 366 for the keyword 365 include learning modules x1, x2, and x3, indicated by reference numerals 368, 370, and 372 respectively.

The learning module x1 has a learning objective entitled “Battle of Gettysburg”, content module x1, and assessment x1. The learning module x2 has a learning objective entitled “Reasons for Civil War”, content module x2, and assessment module x2. The learning module x3 has a learning objective entitled “Abraham Lincoln”, content module x3, and assessment module x3. In other embodiments, the number and type of content and assessment components of each of the learning modules 366 may differ.

To facilitate searching, in some embodiments various related search keywords or “tags” may be associated with the learning modules when the learning modules are created and stored. In some embodiments, these tags may be provided by the entity creating the learning module. In other embodiments, the tags or keywords may be automatically extracted from the components of the learning module (e.g. using semantic learning). For example, tags may include some components of the learning objective, words that occur most frequently in the content modules and so on.

Referring to the interface 360 shown in FIG. 43, a second keyword 374 or query (“PRESIDENTS”) is inputted in the field 362 to generate other relevant learning modules 376. As shown, the generated learning modules 376 include learning modules y1, y2, and x3, indicated by reference numerals 378, 380, and 372 respectively.

The learning module y1 has a learning objective entitled “Barack Obama”, content module y1, and assessment y1. The learning module y2 has a learning objective entitled “George W. Bush”, content module y2, and assessment module y2. The learning module x3, as described above, has a learning objective entitled “Abraham Lincoln”, content module x3, and assessment module x3. As shown, the learning module x3 is common to the searches in both FIGS. 42 and 43.

Generally, the learning modules provide a more granular method to search for and reuse course curriculum that has already been developed. For example, to develop an introductory course on the history of U.S. politics, a course designer may select some learning modules that are provided in different searches, for example by using the search interface 360. As each of the learning modules includes at least one content module and/or assessment modules, it reduces the need for the designer from having to develop content and/or assessment modules from scratch for each particular desired learning objective, as he or she will be able to use (and where desired modify) the existing components of the learning modules selected for their course.

Furthermore, the modification, updates, and/or other improvements that the designer makes on the existing learning module may be repackaged as a new or improved learning module, which may then stored for use by other designers. This tends to provide for incremental improvement and aggregation of knowledge over time as the repository of learning modules can continue to grow.

In some embodiments, the results returned by the search interface 360 may be based on search engine logic, which can include semantic searching, natural language, Boolean logic, or other searching techniques as are known.

In some embodiments a course design module may be adapted to guide a user through the course development process to develop a pedagogically sound course. For example, the course design module may check whether a content module is associated with at least one learning objective, and if no such associations exist, the course design module may remind the user that there may be no content modules that address the learning objective. A similar check may be performed for assessment modules

For instance, turning now to FIG. 45, in some embodiments a course design module may be adapted to allow the user to associate learning objectives with one or more course items (e.g. course content modules, assessments, and so on). For example, as shown in FIG. 45 an Objectives tab 700 on a particular page may provide the user with the ability to associate learning objectives by selecting a button 702 or other control.

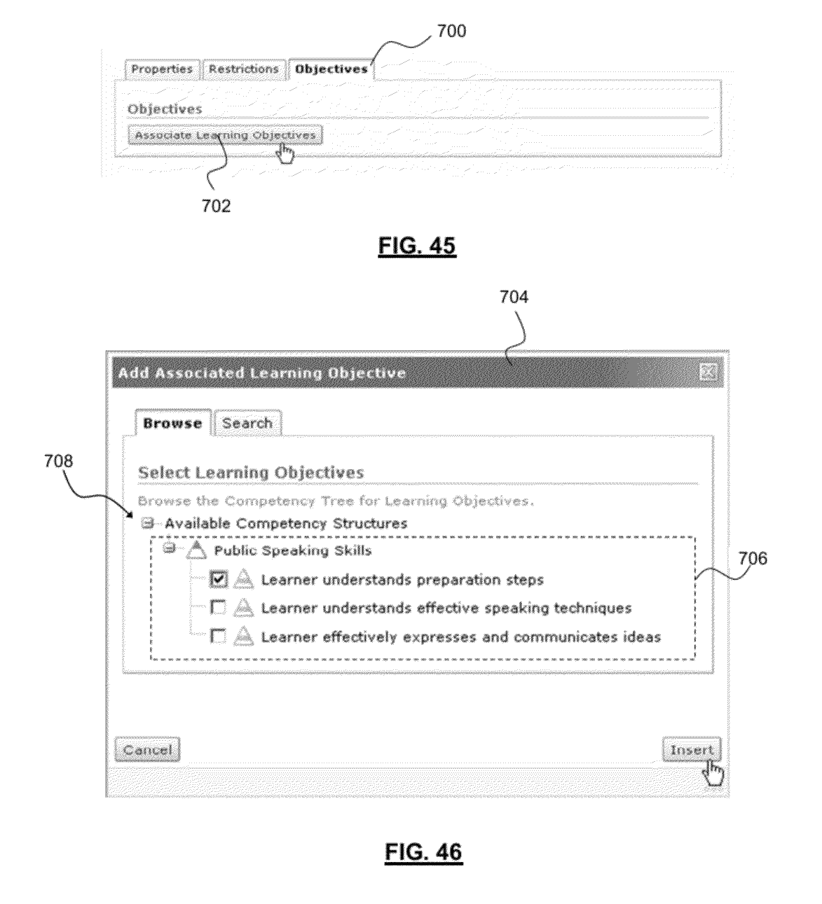

Once the button 702 has been activated, an Add Associated Learning Objectives page 704 may be displayed, as shown in FIG. 46. In some embodiments this page 704 may allow the user to navigate (e.g. by browsing or searching) to select one or more learning objectives. For example, as shown, the page 704 may display a plurality of learning objectives 706 related to public speaking under a tree-structure 708 that displays available competency structures which can be selected by the user.

In some embodiments one or more learning objectives may be associated without evaluation methods. For example, as shown in FIG. 47 a page 710 may displayed that indicates that a particular learning objective is not being evaluated. This may be useful where a user wants to align a particular course to a particular learning objective without providing an evaluation or assessment. This may help indicate the coverage of a learning objective within a course without requiring any formal assessment of that item, and generally without an impact on goal management or automatic competency evaluations.

In some such embodiments, as shown in FIG. 47, the user may be prompted (e.g. by text or via a link 712) to add an assessment method if they so desire.

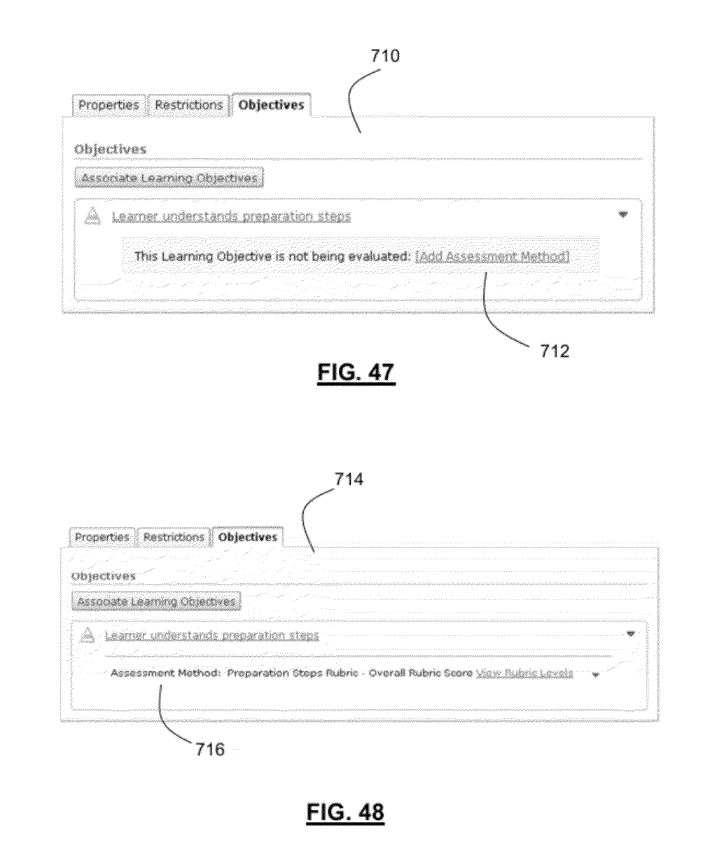

In some embodiments, one or more learning objectives may be associated with evaluation or assessment modules. For example, as shown in FIG. 48, a page 714 may be displayed that allows one or more learning objectives to be associated, and includes an identified assessment method 716. This may be useful when a user wants to evaluate a particular item with a numeric grade or a rubric, and wants to have views into user and class achievement, but may not want the item's assessment to be used for goal management, or automatic competency evaluation, which might be done in the future. This may also appropriate for diagnostic and formative assessments, for example.

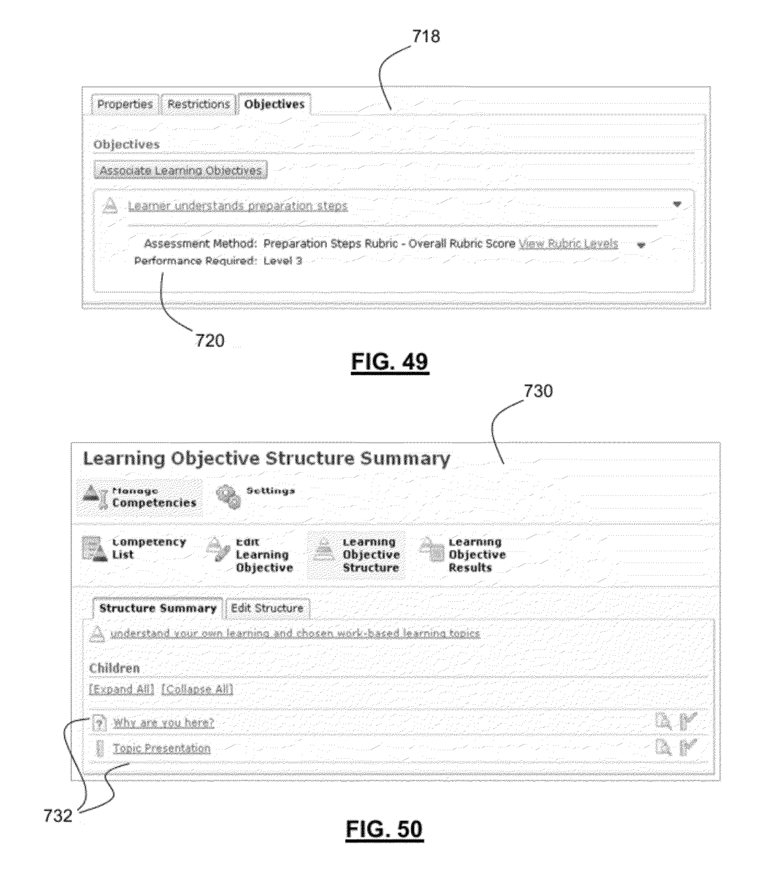

In some embodiments, goal management may also be provided. For example, as shown in FIG. 49, a page 718 may be presented that allows learning objectives to be associated and which also identifies a goal 720 for the purposes of goal management. This may be useful when a user wants to evaluate an item with a numeric grade or a rubric, wants to have views into user and class achievement, and wants to use the assessment of the item for automatic competency evaluation. This may also be appropriate for summative assessments in courses that track competency and learning objective achievement.

Turning now to FIG. 50, in some embodiments a course design module may be adapted to allow learning objectives to be associated with particular content modules. For example, as shown a page 730 may be displayed that allows the structure of one or more learning objectives to be edited, and may include one or more content modules 732 associated therewith. Using the course design module, users can associate content modules and topics with learning objectives, for example through the Objectives tab 700. Aligning Content may assist in providing a clearer picture of “objective coverage within a course” when examining the structure of a learning objective. It can also provide guidance for releasing remedial or advanced material related to one or more learning objectives based on the level of achievement for an aligned assessment.

Aligning content to learning objectives may also useful for publishing materials to a repository or other database. For example, if a course design module is suitably configured, published learning modules can be automatically classified in a repository as described above.

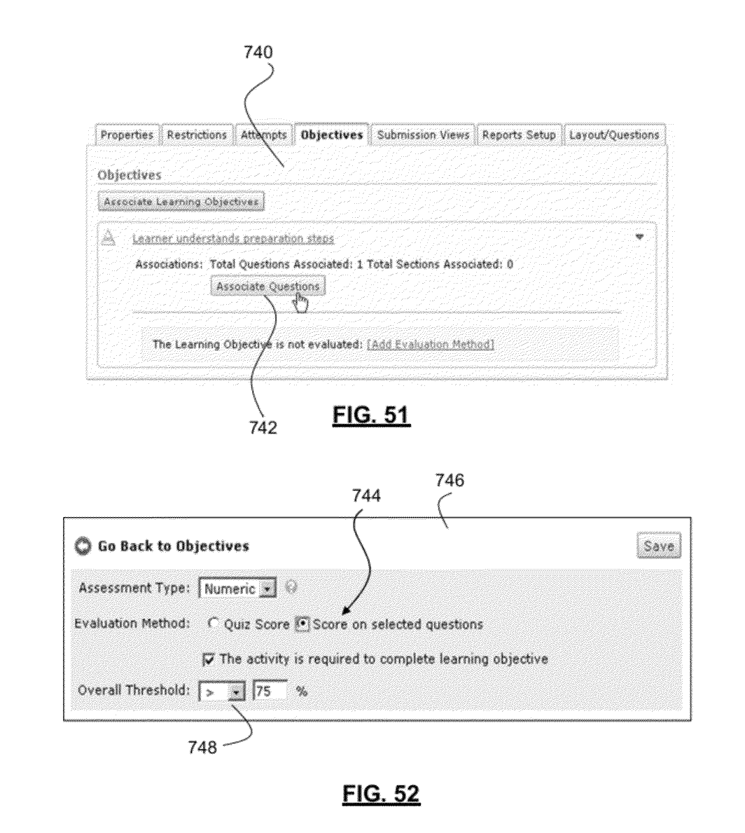

Turning now to FIG. 51, in some embodiments one or more subcomponents of an assessment may be associated with a particular learning objective. For example, a user may desire to associate one or more questions in a quiz with a particular learning objective, since in practice a subset of quiz questions are often associated with particular learning objectives (as opposed to an entire quiz). Accordingly, as shown specific quiz questions within a quiz (or other subcomponents of an assessment) can be aligned to a learning objective using page 740 by selecting an Associate Questions button 742.

In addition, as shown in FIG. 52 a user may be prompted to provide a learning objective assessment method for quizzes 744 (called “Score on selected questions”) as shown in page 746. This may be a numeric score of all questions in the quiz that are aligned to the particular learning objective, which may allow for more specific evaluation of a particular learner's performance with respect to that learning objective. In particular, this may provide for more powerful diagnostic and formative quizzes covering multiple learning objectives, and allow instructors to more easily find areas of strength and weakness in a class by looking at resulting scores for the learners.

As shown, in some embodiments a release condition 748 for the score may also be specified.

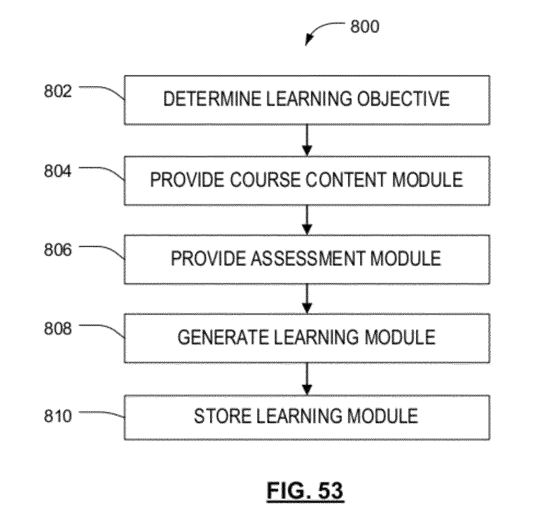

Referring now to FIG. 53, illustrated therein an educational method 800 for developing an educational course. The educational method 800 may be executed by one or more components of the system 10, for example, by the processing device (server) 32.

In the embodiment as shown, the method 800 begins at step 802. In other embodiments the order of performance of the steps of the method may differ. For example, some of the steps may be performed simultaneously or in a different order.

At step 802, at least one learning objective is defined for the course. In some embodiments the learning objective may be defined based on input from one or more users. In other embodiments, the learning objective may be provided by the system, for example, based on guidelines provided by educational standard institutions (e.g. government).

At step 804, at least one course content module having educational related to the at least one learning objective for the course is provided.

At step 806, at least one assessment module for assessing a learner's performance in the course is provided.

At step 808, at least one learning module is generated based on at least one of the learning objectives. Each learning module includes one or more course content modules and assessment modules associated with the learning objective. In some embodiments, a learning module may have only course content modules. In some embodiments, a learning module may have only assessment modules. In other embodiments, a learning module may have both course content modules and assessment modules.

At step 810, the generated learning module is stored in a data storage device.

In some embodiments, the method 810 includes step 812 wherein the stored learning modules are made available for use to develop at least one other educational course.

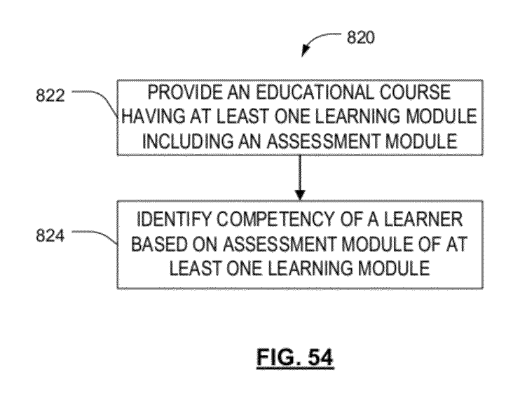

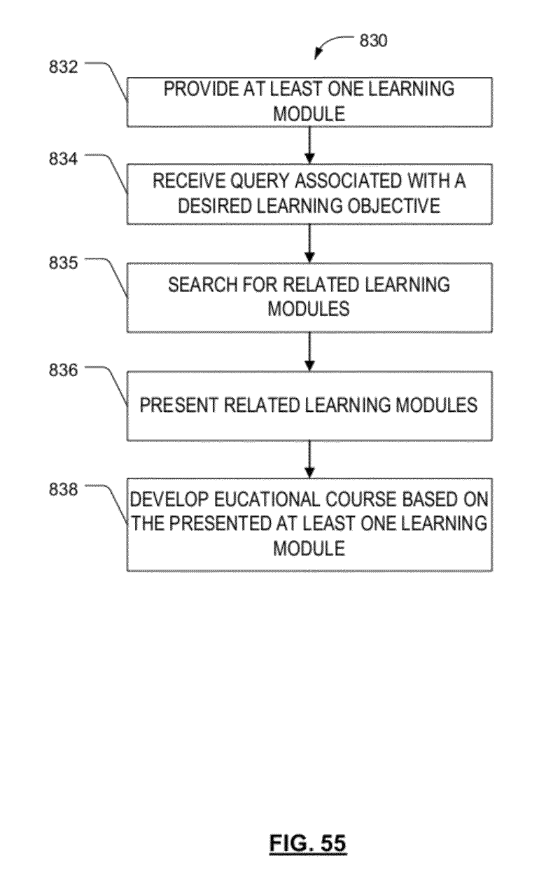

Referring now to FIG. 54, illustrated therein an educational method 820 for determining a learner's competence on a given learning objective. The educational method 820 may be executed by one or more components of the system 10, for example, by the processing device (server) 32.

In the embodiment as shown, the method 820 begins at step 822. At step 822 an educational course having at least one learning module is provided. The learning module is generated based on the learning objective and includes at least one assessment module associated with that learning objective. In some embodiments, the educational course may be an educational course developed in accordance with method 800 or some embodiments of the educational course 330 as described herein above.

At step 824, a competency level of at least one learner on the learning objective is identified based on the at least one assessment module of the at least one learning module.

In some embodiments, the step 824may include administering the assessment module to the learner and analyzing the results of the administered assessment module.

In some embodiments, more than one assessment module may be administered throughout the course. For example, assessment modules A2 and A5 shown in FIG. 41 and described above measure the competency level of the at least one learner for the learning objective LO2. The assessment modules A2 and A5 may be administered at different times (A2 as part of the mid-term assessment and A5 as part of the end-of-term assessment). However, regardless of when the assessment modules A2 and A5 were administered, they may both be used to identify the competency level of the learner for the associated learning objective LO2.

Referring now to FIG. 55, illustrated therein is a method 830 for developing an educational course according to some embodiments. The method 830 may be executed by one or more components of the system 10, for example, by the processing device (server) 32.

In the embodiment as shown, the method 830 begins at step 832. In other embodiments the order of performance of the steps of the method 210 may differ. For example, some of the steps may be performed simultaneously or in a different order.

At step 832, at least one learning module is provided. The learning module may be generated based on a learning objective and includes one or more content modules and assessment modules associated with that learning objective. In some embodiments, the educational course may be an educational course developed in accordance with method 800 or some embodiments of the educational course 330 as described herein above.

At step 834, a query associated with at least one desired learning objective is received. This query could be a particular learning objective or some other query (e.g. natural language or Boolean query).

At step 835, a search for one or more learning modules that are related to the at least one query is performed. Each learning module includes one or more content modules and assessment modules associated with that learning objective.

At step 836, at least one learning module that is related to the desired learning objective is presented in response to the at least one query. The learning modules may be presented using different search engine techniques, such as based on tags or keywords specified in a learning module, based on semantic searching, and so on.

At step 838, the educational course is developed based on at least one of the learning modules presented in step 216. For instance, one or more of the learning modules may be added to the course, such as by using a course design wizard.

While the above description provides examples of some embodiments, it will be appreciated that some features and/or functions of the described embodiments are susceptible to modification without departing from the spirit and principles of operation of the described embodiments. Accordingly, what has been described above has been intended to be illustrative of some embodiments of the invention and non-limiting and it will be understood by persons skilled in the art that other variants and modifications may be made without departing from the scope of the claims appended hereto.

1. A computer-implemented method for developing an educational course comprising:
defining at least one learning objective for the course;
providing at least one course content module having educational material related to the at least one learning objective for the course;
providing at least one assessment module for assessing a learner's performance in the course;
generating at least one learning module based on at least one of the learning objectives, the learning module including one or more course content modules and assessment modules associated with that learning objective; and
storing the at least one learning module in a data storage device.

2. The method of claim 1, wherein the course includes a plurality of course units, each course unit being associated with one or more course content modules and assessment modules, and wherein the course content modules and assessment modules of the course units are defined independently of the learning objectives.

3. The method of claim 1, further comprising making the at least one learning module available for use to develop at least one other educational course.

4. The method of claim 1, wherein at least one of the learning modules has at least one course content module and at least one assessment module associated therewith such that that learning module is self-contained and comprehensive.

5. The method of claim 1, further comprising generating an alert if there is no course content module associated with the at least one learning objective.

6. The method of claim 1, further comprising generating an alert if there is no assessment module associated with the at least one learning objective.

7. The method of claim 1, further comprising generating an alert when at least one of the course content modules is not associated with at least one of the assessment modules.

8. The method of claim 1, further comprising generating an alert when at least one of the assessment modules is not associated with at least one of the course content modules.

9. A computer-implemented educational method comprising:
providing an educational course having at least one learning module, the at least one learning module being generated based on a learning objective and including at least one assessment module associated with that learning objective; and
identifying a competency level of at least one learner on the learning objective based on the at least one assessment module of the at least one learning module.

10. The method of claim 9, wherein the course includes a plurality of course units, each course unit being associated with one or more assessment modules, and wherein the assessment modules of the course units are defined independently of the learning objectives.

11. The method of claim 10, wherein the assessment module is an informational assessment module.

12. The method of claim 11, wherein the method further comprises presenting one or more remedial activities based on the competency level of the learner in response to the informational assessment module.

13. The method of claim 11, wherein the method further comprises presenting one or more mastery activities based on the competency level of the learner in response to the informational assessment module.

14. A computer-implemented method for developing an educational course comprising:
receiving at least one query associated with at least one desired learning objective;
searching for one or more learning modules that are related to the at least one query, each learning module having been generated based on a learning objective and including one or more content modules and assessment modules associated with that learning objective;
if one or more related learning modules are found, presenting the related one or more learning modules; and
developing the educational course based on at least one of the presented one or more learning modules.

15. The method of claim 14, wherein the course includes a plurality of course units, each course unit being associated with one or more course content modules and assessment modules of at least one of the presented learning modules, and wherein the course content modules and assessment modules of the course units are defined independently of learning objectives for that course.

16. An educational system comprising:
at least one data storage device; and
at least one processor coupled to the at least one data storage device, the at least one processor being adapted to:
define at least one learning objective for the course,
provide at least one course content module having educational material related to the at least one learning objective for the course,
provide at least one assessment module for assessing a learner's performance in the course,
generate at least one learning module based on at least one of the learning objectives, the learning module including one or more course content modules and assessment modules associated with that learning objective, and
store the at least one learning module in a data storage device.

17. The system of claim 16, wherein the course includes a plurality of course units, each course unit being associated with one or more course content modules and assessment modules, and wherein the course content modules and assessment modules of the course units are defined independently of the learning objectives.

18. The system of claim 16, further comprising making the at least one learning module available for use to develop at least one other educational course.

19. The system of claim 16, wherein at least one of the learning modules has at least one course content module and at least one assessment module associated therewith such that that learning module is self-contained and comprehensive.

20. The system of claim 16, the at least one processor is further adapted generate an alert if there is no course content module associated with the at least one learning objective.

21. The system of claim 16, the at least one processor is further adapted generate an alert if there is no assessment module associated with the at least one learning objective.

22. The system of claim 16, the at least one processor is further adapted generate an alert an alert when at least one of the course content modules is not associated with at least one of the assessment modules.

23. The system of claim 16, the at least one processor is further adapted generate an alert an alert when at least one of the assessment modules is not associated with at least one of the course content modules.

24. An educational system comprising:
at least one data storage device; and
at least one processor coupled to the at least one data storage device, the at least one processor being adapted to:
provide an educational course having at least one learning module, the at least one learning module being generated based on a learning objective and including at least one assessment module associated with that learning objective, and
identify a competency level of at least one learner on the learning objective based on the at least one assessment module of the at least one learning module.

25. The system of claim 24, wherein the course includes a plurality of course units, each course unit being associated with one or more assessment modules, and wherein the assessment modules of the course units are defined independently of the learning objectives.

26. The system of claim 25, wherein the assessment module is an informational assessment module.

27. The system of claim 26, wherein the method further comprises presenting one or more remedial activities based on the competency level of the learner in response to the informational assessment module.

28. The method of claim 25, wherein the method further comprises presenting one or more mastery activities based on the competency level of the learner in response to the informational assessment module.

29. An educational system comprising:
at least one data storage device; and
at least one processor coupled to the at least one data storage device, the at least one processor being adapted to:
receive at least one query associated with at least one desired learning objective;
search for one or more learning modules that are related to the at least one query, each learning module having been generated based on a learning objective and including one or more content modules and assessment modules associated with that learning objective;
if one or more related learning modules are found, present the related one or more learning modules; and
develop the educational course based on at least one of the presented one or more learning modules.

30. The system of claim 29, wherein the course includes a plurality of course units, each course unit being associated with one or more course content modules and assessment modules of at least one of the presented learning modules, and wherein the course content modules and assessment modules of the course units are defined independently of learning objectives for that course.

31. A course design system for designing a course for an electronic learning system, comprising:
at least one input device;
at least one output device;
at least one data storage device; and
at least one processor coupled to the at least one data storage device, the at least one processor being adapted to:
display one or more pages on the at least one output device adapted to allow a user to:
define at least one learning objective for the course;
provide at least one course content module having educational material; and
provide at least one assessment module;
receive at least one input via the at least one input device to associate at least one of the course content module and assessment module to the at least one learning objective to generate at least one learning module; and
store the at least one learning module in a repository data storage device.

32. The course design module of claim 31, wherein the processor is further adapted to identify a competency level of at least one learner on the learning objective based on the at least one assessment module of the at least one learning module.

33. The course design system of claim 31 wherein the at least one processor is adapted to display at least one page adapted to:
receive at least one query associated with at least one desired learning objective;
search the repository for one or more learning modules that are related to the at least one query; and
if one or more related learning modules are found, presenting the related one or more learning modules.

34. The course design system of claim 33, wherein the at least one processor is adapted to receive an input associating at least one of the related learning modules with a subsequent course.
